(19) United States
(12) Patent Application Publication
(10) Pub. No.: US 2023/0042016 A1
(43) Pub. Date: Feb. 9, 2023

(54) LAMINATE

(71) Applicant: FUJIFILM Corporation, Tokyo (JP)

(72) Inventor: Takeo KIDO, Shizuoka (JP)

(73) Assignee: FUJIFILM Corporation, Tokyo (JP)

(21) Appl. No.: 17/871,995

(22) Filed: Jul. 25, 2022

(30) Foreign Application Priority Data
Jul. 30, 2021 (JP) 2021-125280

(51) Int. Cl. B32B 15/085; B32B 15/20; B32B 7/12

(52) U.S. Cl. CPC B32B 15/085; B32B 15/20; B32B 7/12; B32B 2307/51; B32B 2307/204; B32B 2307/732; B32B 2250/03; B32B 2305/55

(57) ABSTRACT

An object of the present invention is to provide a laminate having a smaller transmission loss in a high frequency band.

A laminate having a metal layer and a resin layer in contact with at least one surface of the metal layer, in which a dielectric loss tangent of the resin layer at a temperature of 23° C. and a frequency of 28 GHz is less than 0.002, and an average length RSm at an interface between the metal layer and the resin layer in a cross-section along a thickness direction of the laminate is 1.2 μm or less.

### CROSS-REFERENCE TO RELATED APPLICATIONS

The present application claims priority under 35 U.S.C. § 119 to Japanese Patent Application No. 2021-125280 filed on Jul. 30, 2021. The above application is hereby expressly incorporated by reference, in its entirety, into the present application.

### BACKGROUND OF THE INVENTION

### 1. Field of the Invention

The present invention relates to a laminate.

### 2. Description of the Related Art

Higher frequency bands than ever before have been used in a 5th generation (5G) mobile communication system, which is considered to be next-generation communication technology. Therefore, a film substrate for a circuit board for a 5G mobile communication system is required to have a low dielectric loss tangent and a low water absorption from the viewpoint of reducing a transmission loss in a high frequency band, and development of film substrates using various materials is in progress.

For example, JP6019012B describes a high frequency circuit board consisting of a laminate in which a thermoplastic liquid crystal polymer film is laminated on a metal foil having irregularities on a surface thereof, the metal foil having a surface roughness (Rz) and a ratio (Rz/S) thereof to an interval (S) between the irregularities on the surface within specific ranges.

### SUMMARY OF THE INVENTION

The laminate having a metal layer and a resin layer as described above is required to have a further reduction in a transmission loss in a high frequency band in a case where the laminate is used for a high frequency circuit board.

The present inventors have manufactured a laminate having a metal layer and a resin layer with reference to the film described in JP6019012B, and have found that there is room for a further improvement in a transmission loss of the laminate in a high frequency band.

The present invention has been made in view of the circumstances, and an object thereof is to provide a laminate having a smaller transmission loss in a high frequency band.

The present inventors have conducted intensive studies to accomplish the object, and as a result, they have found that the object can be accomplished by the following configurations.

[1] A laminate comprising:

a metal layer; and

a resin layer in contact with at least one surface of the metal layer,

in which a dielectric loss tangent of the resin layer at a temperature of 23° C. and a frequency of 28 GHz is less than 0.002, and

an average length RSm of a roughness curve element at an interface between the metal layer and the resin layer in a cross-section along a thickness direction is 1.2 μm or less.

[2] The laminate as described in [1],

in which the resin layer includes a liquid crystal polymer.

[3] The laminate as described in [2],

in which the liquid crystal polymer includes two or more kinds of repeating units derived from a dicarboxylic acid.

[4] The laminate as described in [2] or [3],

in which the liquid crystal polymer has at least one selected from the group consisting of a repeating unit derived from 6-hydroxy-2-naphthoic acid, a repeating unit derived from an aromatic diol, a repeating unit derived from terephthalic acid, and a repeating unit derived from 2,6-naphthalenedicarboxylic acid.

[5] The laminate as described in any one of [1] to [4],

in which the resin layer includes a polyolefin.

[6] The laminate as described in [5],

in which a content of the polyolefin is 0.1% to 40% by mass with respect to a total mass of the resin layer.

[7] The laminate as described in [5] or [6],

in which a dispersed phase including the polyolefin is formed in the resin layer, and

an average dispersion diameter of the dispersed phase in an observation image obtained by observing a cross-section of the resin layer is 0.01 to 10 μm.

[8] The laminate as described in any one of [1] to [7],

in which the resin layer has an adhesive resin layer and a layer including a liquid crystal polymer in this order from a metal layer side.

[9] The laminate as described in [8],

in which a thickness of the adhesive resin layer is 1 μm or less.

[10] The laminate as described in [8] or [9],

in which an elastic modulus of the adhesive resin layer is 0.8 GPa or more.

[11] The laminate as described in any one of [8] to [10],

in which a content of a solvent included in the adhesive resin layer is 0 to 200 ppm by mass with respect to a total mass of the adhesive resin layer.

[12] The laminate as described in any one of [1] to [11],

in which the metal layer is a copper layer.

According to the present invention, it is possible to provide a laminate having a smaller transmission loss in a high frequency band.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

In notations for a group (atomic group) in the present specification, in a case where the group is cited without specifying whether it is substituted or unsubstituted, the group includes both a group having no substituent and a group having a substituent as long as this does not impair the spirit of the present invention. For example, an “alkyl group” includes not only an alkyl group having no substituent (unsubstituted alkyl group), but also an alkyl group having a substituent (substituted alkyl group). In addition, an “organic group” in the present specification refers to a group including at least 1 carbon atom.

In the present specification, in a case where a resin layer or a film has an elongated shape, a width direction means a lateral direction and a transverse direction (TD) of the resin layer or the film, and a length direction means a longitudinal direction and a machine direction (MD) of the resin layer or the film.

In the present specification, for each component, one kind of substance corresponding to each component may be used alone, or two or more kinds thereof may be used in combination. Here, in a case where two or more kinds of substances are used for each component, the content of the component indicates a total content of two or more substances unless otherwise specified.

In the present specification, “to” is used in a meaning including numerical values denoted before and after “to” as a lower limit value and an upper limit value, respectively.

In the present specification, the dielectric loss tangent of the resin layer or the resin included in the resin layer as measured under the conditions of a temperature of 23° C. and a frequency of 28 GHz is also described as a “standard dielectric loss tangent”.

In the present specification, the “film width” means a distance between both ends of a long resin layer or film in the width direction.

Laminate

The laminate according to an embodiment of the present invention has a metal layer and a resin layer in contact with at least one surface of the metal layer, in which a standard dielectric loss tangent of the resin layer is less than 0.002, and an average length RSm (hereinafter also referred to as an “interface RSm”) of a roughness curve element at an interface between the metal layer and the resin layer in a cross-section along a thickness direction of the laminate is 1.2 μm or less.

By defining the standard dielectric loss tangent of the resin layer contained in the laminate and the roughness of the interface between the metal layer and the resin layer as described above, a laminate having a smaller transmission loss in a high frequency band can be obtained. In particular, the transmission loss of the laminate having a metal layer and a resin layer consists of a conductor loss of the metal layer and a dielectric loss of the resin layer, and an electric signal in the high frequency band flows through a surface layer of the metal layer, and therefore, it is considered that the transmission loss in a high frequency band of the laminate is further suppressed by setting the RSm at an interface to be in the range.

Hereinafter, in a case where the transmission loss in a high frequency band in the laminate having the metal layer and the resin layer is smaller, it is also described that “the effect of the present invention is more excellent”.

Hereinafter, the configuration of the laminate according to the embodiment of the present invention will be described in detail.

The laminate has at least one metal layer and at least one resin layer, and the metal layer is arranged so as to be in contact with a surface of the resin layer.

The number of metal layers and resin layers contained in the laminate is not limited, and the number of each layer may be only one or two or more.

The laminate may have only one metal layer on one side of one resin layer, or may have two metal layers on both sides of one resin layer. The laminate preferably has at least a layer configuration in which a metal layer, a resin layer, and a metal layer are laminated in this order.

The RSm at an interface in the laminate according to the embodiment of the present invention is 1.2 μm or less. The RSm at an interface of the laminate is preferably 0.9 μm or less, and more preferably 0.6 μm or less from the viewpoint that the effect of the present invention is more excellent. The lower limit value is not particularly limited, but is, for example, 0.1 μm or more, and from the viewpoint that the adhesive force can be ensured, the lower limit value is preferably 0.3 μm or more.

Furthermore, in a case where the laminate according to the embodiment of the present invention has two metal layers and two interfaces between the metal layers and the resin layer, it is meant that the RSm of at least one interface is 1.2 μm or less. In a case where the laminate has two metal layers, it is preferable that any of RSm's at the two interfaces is 1.2 μm or less, and it is more preferable that the RSm's at the two interfaces are within the preferred range.

The RSm at an interface of the laminate is obtained in accordance with JIS B0601:2001. Specifically, a cross-section in the thickness direction (lamination direction) of the laminate is observed using a scanning electron microscope (SEM) (magnification: 50,000 times), and the cross-sectional curve of an interface between the metal layer and the resin layer in the obtained observation image is measured by tracing the interface between the metal layer and the resin layer over a measurement length of 2,000 nm by an image treatment. Furthermore, from the obtained cross-sectional curve, a roughness curve is determined by a roughness curve filter having a cutoff value of 700 nm (high-wavelength side) and a cutoff value of 10 nm (low-wavelength side). Measurement of this roughness curve is performed on SEM observation images at 10 points with different cross-sectional positions, and the lengths of the roughness curve elements at a reference length (=a cutoff value on the high wavelength side) are arithmetically averaged to determine the RSm at an interface.

Metal Layer

Examples of a material constituting the metal layer include metals used for electrical connection. Examples of such metals include copper, gold, silver, nickel, aluminum, and alloys including any of these metals. Examples of the alloy include a copper-zinc alloy, a copper-nickel alloy, and a zinc-nickel alloy.

As the metal layer, a copper layer is preferable from the viewpoint that the conductivity and the workability are excellent. The copper layer is a layer consisting of copper or a copper alloy including 95% by mass or more of copper. Examples of the copper layer include a rolled copper foil produced by a rolling method, and an electrolytic copper foil produced by an electrolysis method. The metal layer may be subjected to a chemical treatment such as pickling.

In a case where a metal foil such as a copper foil is used for manufacturing the laminate, the RSm on at least one surface of the metal foil is preferably 1.2 μm or less, more preferably 0.9 μm or less, and still more preferably 0.6 μm or less. The lower limit value is not particularly limited, but is preferably 0.1 μm or more, and more preferably 0.3 μm or more.

By using a metal foil having an RSm of at least one surface (a surface in contact with the resin layer) thereof in the range, it is easier to manufacture the laminate of the embodiment of the present invention, in which the RSm at an interface is defined.

Examples of the metal foil having an RSm on a surface thereof in the range include a non-roughened copper foil, which is available on the market.

The RSm on a surface of the metal foil can be measured according to a method for measuring the RSm at an interface in the laminate from a cross-section obtained by subjecting a metal foil in a resin for observation to an embedding treatment, and then cutting the embedding-treated metal foil along the thickness direction.

A thickness of the metal layer is not particularly limited, and is appropriately selected depending on the application of a circuit board, but the thickness is preferably 4 to 100 μm, and more preferably 10 to 35 μm in terms of wiring line conductivity and economy.

Resin Layer

Dielectric Characteristics

The resin layer contained in the laminate of the embodiment of the present invention is a resin layer having a standard dielectric loss tangent of less than 0.002.

The standard dielectric loss tangent of the resin layer is preferably 0.0015 or less, and more preferably 0.001 or less. The lower limit value is not particularly limited, and may be 0.0001 or more.

A relative permittivity of the resin layer varies depending on the application, but is preferably 2.0 to 4.0, and more preferably 2.5 to 3.5.

The dielectric characteristics including the standard dielectric loss tangent of the resin layer can be measured by a cavity resonator perturbation method. A specific method for measuring the dielectric characteristics of the resin layer will be described in the Example column which will be described later.

Configuration of Resin Layer

The configuration of the resin layer is not particularly limited as long as the dielectric loss tangent of the resin layer is less than 0.002.

The resin layer may have only a polymer layer including a polymer having a low standard dielectric loss tangent (preferably less than 0.002) alone, or may have two or more layers including the polymer layer.

Above all, from the viewpoint that the adhesiveness to the metal layer is more excellent, the resin layer preferably has a polymer layer including a polymer having a low standard dielectric loss tangent (more preferably a liquid crystal polymer) and an adhesive resin layer.

The adhesive resin layer is preferably arranged on a surface of the resin layer in contact with the metal layer. That is, in a case where the resin layer has an adhesive resin layer, it is preferable that the adhesive resin layer and the polymer layer are arranged in this order from a metal layer side.

For example, in a case where two metal layers are arranged on both sides of the resin layer, it is preferable that the metal layer, the adhesive resin layer, the polymer layer, the adhesive resin layer, and the metal layer are laminated in this order.

Hereinafter, the resin layer having the polymer layer and the adhesive resin layer will be described in detail, but the resin layer may have the polymer layer alone as described above. That is, the polymer layer described below may be included alone as a resin layer in the laminate.

Polymer Layer

The polymer layer is a layer including a polymer having a low standard dielectric loss tangent.

The standard dielectric loss tangent of the polymer included in the polymer layer is preferably less than 0.002, more preferably 0.0015 or less, and still more preferably 0.001 or less. The lower limit value is not particularly limited, and may be, for example, 0.0001 or more.

The type of the polymer included in the polymer layer is not particularly limited, and examples thereof include a liquid crystal polymer, a fluororesin, a polyimide, and a modified polyimide. Among those, the liquid crystal polymer or the fluororesin is preferable, and the liquid crystal polymer is more preferable.

Hereinafter, the configuration of the polymer layer will be described in more detail by taking the polymer layer including the liquid crystal polymer as a typical example.

Liquid Crystal Polymer

The liquid crystal polymer included in the resin layer and the polymer layer is not particularly limited, and examples thereof include a liquid crystal polymer which can be melt-molded.

As the liquid crystal polymer, a thermotropic liquid crystal polymer is preferable. The thermotropic liquid crystal polymer means a polymer which exhibits liquid crystallinity in a molten state in case of heating it in a predetermined temperature range.

The thermotropic liquid crystal polymer is not particularly limited as long as it is a melt-moldable liquid crystal polymer, and examples thereof include a thermoplastic liquid crystal polyester and a thermoplastic polyester amide with an amide bond introduced into the thermoplastic liquid crystal polyester.

As the liquid crystal polymer, for example, the thermoplastic liquid crystal polymer described in WO2015/064437A and JP2019-116586A can be used.

More specific examples of the liquid crystal polymer include a thermoplastic liquid crystal polyester or thermoplastic liquid crystal polyester amide having a repeating unit derived from at least one selected from the group consisting of an aromatic hydroxycarboxylic acid, an aromatic or aliphatic diol, an aromatic or aliphatic dicarboxylic acid, an aromatic diamine, an aromatic hydroxyamine, and an aromatic aminocarboxylic acid.

Examples of the aromatic hydroxycarboxylic acid include parahydroxybenzoic acid, metahydroxybenzoic acid, 6-hydroxy-2-naphthoic acid, and 4-(4-hydroxyphenyl)benzoic acid. These compounds may have substituents such as a halogen atom, a lower alkyl group, and a phenyl group. Among these, the parahydroxybenzoic acid or the 6-hydroxy-2-naphthoic acid is preferable.

As the aromatic or aliphatic diol, the aromatic diol is preferable. Examples of the aromatic diol include hydroquinone, 4,4′-dihydroxybiphenyl, 3,3′-dimethyl-1,1′-biphenyl-4,4′-diol, and acylated products thereof, and hydroquinone or 4,4′-dihydroxybiphenyl is preferable.

As the aromatic or aliphatic dicarboxylic acid, the aromatic dicarboxylic acid is preferable. Examples of the aromatic dicarboxylic acid include terephthalic acid, isophthalic acid, and 2,6-naphthalenedicarboxylic acid, and terephthalic acid is preferable.

Examples of the aromatic diamine, the aromatic hydroxyamine, and the aromatic aminocarboxylic acid include p-phenylenediamine, 4-aminophenol, and 4-aminobenzoic acid.

The liquid crystal polymer preferably includes a repeating unit derived from a dicarboxylic acid (an aromatic or aliphatic dicarboxylic acid) among the repeating units, and from the viewpoint that the low dielectric constant is more excellent, the liquid crystal polymer more preferably include two or more kinds of the repeating units. As the dicarboxylic acid in this case, the aromatic dicarboxylic acid is preferable, and terephthalic acid, isophthalic acid, or 2,6-naphthalenedicarboxylic acid is more preferable.

In addition, it is preferable that the liquid crystal polymer has at least one selected from the group consisting of the repeating units represented by Formulae (1) to (3).

—O—Ar1-CO— (1)

—CO—Ar2-CO— (2)

—X—Ar3-Y— (3)

In Formula (1), Ar1 represents a phenylene group, a naphthylene group, or a biphenylylene group.

In Formula (2), Ar2 represents a phenylene group, a naphthylene group, a biphenylylene group, or a group represented by Formula (4).

In Formula (3), Ar3 represents a phenylene group, a naphthylene group, a biphenylylene group, or the group represented by Formula (4), and X and Y each independently represent an oxygen atom or an imino group.

—Ar4-Z—Ar5- (4)

In Formula (4), Ar4 and Ar5 each independently represent a phenylene group or a naphthylene group, and Z represents an oxygen atom, a sulfur atom, a carbonyl group, a sulfonyl group, or an alkylene group.

The phenylene group, the naphthylene group, and the biphenylylene group may have a substituent selected from the group consisting of a halogen atom, an alkyl group, and an aryl group.

Among those, the liquid crystal polymer preferably has at least one selected from the group consisting of the repeating unit derived from an aromatic hydroxycarboxylic acid represented by Formula (1), the repeating unit derived from an aromatic diol derived from Formula (3), in which both X and Y are oxygen atoms, and the repeating unit derived from an aromatic dicarboxylic acid represented by Formula (2).

In addition, the liquid crystal polymer more preferably has at least a repeating unit derived from an aromatic hydroxycarboxylic acid, still more preferably has at least one selected from the group consisting of the repeating unit derived from parahydroxybenzoic acid and the repeating unit derived from 6-hydroxy-2-naphthoic acid, and particularly preferably has the repeating unit derived from parahydroxybenzoic acid and the repeating unit derived from 6-hydroxy-2-naphthoic acid.

In addition, as another preferred aspect, from the viewpoint that the effect of the present invention is more excellent, the liquid crystal polymer preferably has at least one selected from the group consisting of the repeating unit derived from 6-hydroxy-2-naphthoic acid, the repeating unit derived from an aromatic diol, the repeating unit derived from terephthalic acid, and the repeating unit derived from a 2,6-naphthalenedicarboxylic acid, and more preferably has all of the repeating unit derived from 6-hydroxy-2-naphthoic acid, the repeating unit derived from an aromatic diol, the repeating unit derived from terephthalic acid, and the repeating unit derived from 2,6-naphthalenedicarboxylic acid.

In a case where the liquid crystal polymer includes the repeating unit derived from an aromatic hydroxycarboxylic acid, a compositional ratio thereof is preferably 50% to 65% by mole with respect to all the repeating units of the liquid crystal polymer. In addition, it is also preferable that the liquid crystal polymer has only the repeating unit derived from an aromatic hydroxycarboxylic acid.

In a case where the liquid crystal polymer includes the repeating unit derived from an aromatic diol, a compositional ratio thereof is preferably 17.5% to 25% by mole with respect to all the repeating units of the liquid crystal polymer.

In a case where the liquid crystal polymer includes the repeating unit derived from an aromatic dicarboxylic acid, a compositional ratio thereof is preferably 11% to 23% by mole with respect to all the repeating units of the liquid crystal polymer.

In a case where the liquid crystal polymer includes the repeating unit derived from any of an aromatic diamine, an aromatic hydroxyamine, and an aromatic aminocarboxylic acid, a compositional ratio thereof is preferably 2% to 8% by mole with respect to all the repeating units of the liquid crystal polymer.

A method for synthesizing the liquid crystal polymer is not particularly limited, and the compound can be synthesized by polymerizing the compound by a known method such as melt polymerization, solid phase polymerization, solution polymerization, and slurry polymerization.

As the liquid crystal polymer, a commercially available product may be used. Examples of the commercially available product of the liquid crystal polymer include “LAPEROS” manufactured by Polyplastics Co., Ltd., “Vectra” manufactured by Celanese Corporation, “UENO LCP” manufactured by Ueno Fine Chemicals Industry, Ltd., “SUMIKA SUPER LCP” manufactured by Sumitomo Chemical Company, “Xydar” manufactured by ENEOS LC Co., Ltd., and “Siveras” manufactured by Toray Industries, Inc.

Furthermore, the liquid crystal polymer may form a chemical bond in the polymer layer with a crosslinking agent, a compatible component (reactive compatibilizer), or the like which is an optional component. The same applies to components other than the liquid crystal polymer.

From the viewpoints that a resin layer having a standard dielectric loss tangent of less than 0.002 can be easily produced and the effect of the present invention is more excellent, the standard dielectric loss tangent of the liquid crystal polymer is preferably less than 0.002, more preferably 0.0015 or less, and still more preferably 0.001 or less. The lower limit value is not particularly limited, and may be, for example, 0.0001 or more.

In a case where the resin layer includes two or more kinds of liquid crystal polymers, the “dielectric loss tangent of the liquid crystal polymer” means a mass-average value of the dielectric loss tangents of two or more kinds of liquid crystal polymers.

The standard dielectric loss tangent of the liquid crystal polymer included in the resin layer can be measured by the following method.

First, after performing immersion in an organic solvent (for example, pentafluorophenol) in an amount of 1,000 times by mass with respect to the total mass of the resin layer, the mixture is heated at 120° C. for 12 hours to elute the organic solvent-soluble components including the liquid crystal polymer into the organic solvent. Next, the eluate including the liquid crystal polymer and the non-eluted components are separated by filtration. Subsequently, acetone is added to the eluate as a poor solvent to precipitate a liquid crystal polymer, and the precipitate is separated by filtration.

A standard dielectric loss tangent of the liquid crystal polymer can be obtained by filling the obtained precipitate in a polytetrafluoroethylene (PTFE) tube (outer diameter: 2.5 mm, inner diameter: 1.5 mm, length 10 mm) and filled with a cavity resonator (for example, “CP-531” manufactured by Kanto Electronics Application & Development, Inc.) to measure the dielectric characteristics by a cavity resonator perturbation method under the conditions of a temperature of 23° C. and a frequency of 28 GHz, and correcting the influence of voids in the PTFE tube by a Bruggeman equation and a porosity.

The porosity (volume fraction of the void in the tube) is calculated as follows. The volume of a space inside the tube is determined from the inner diameter and the length of the tube. Next, the weights of the tube before and after filling the precipitate are measured to determine the mass of the filled precipitate, and then the volume of the filled precipitate is determined from the obtained mass and the specific gravity of the precipitate. The porosity can be calculated by dividing the volume of the precipitate thus obtained by the volume of the space in the tube determined above.

Furthermore, in a case where a commercially available product of the liquid crystal polymer is used, a numerical value of the dielectric loss tangent described as a catalog value of the commercially available product may be used.

As for the liquid crystal polymer, the melting point Tm is preferably 250° C. or higher, more preferably 280° C. or higher, and still more preferably 310° C. or higher from the viewpoint that the heat resistance is more excellent.

The upper limit value of the melting point Tm of the liquid crystal polymer is not particularly limited, but is preferably 400° C. or lower, and more preferably 380° C. or lower from the viewpoint that the moldability is more excellent.

The melting point Tm of the liquid crystal polymer can be determined by measuring a temperature at which the endothermic peak appears, using a differential scanning calorimeter (“DSC-60A” manufactured by Shimadzu Corporation). In a case where a commercially available product of the liquid crystal polymer is used, the melting point Tm described as the catalog value of the commercially available product may be used.

A number-average molecular weight (Mn) of the liquid crystal polymer is not particularly limited, but is preferably 10,000 to 600,000, and more preferably 30,000 to 150,000.

The number-average molecular weight of the liquid crystal polymer is a polystyrene-equivalent value measured by GPC, and can be measured by a method similar to the method for measuring the number-average molecular weight of the resin layer.

The liquid crystal polymers may be used alone or in combination of two or more kinds thereof.

A content of the liquid crystal polymer is preferably 40% to 99.9% by mass, more preferably 50% to 95% by mass, and still more preferably 60% to 90% by mass with respect to the total mass of the resin layer.

Furthermore, the content of the liquid crystal polymer and the components described below in the resin layer can be measured by a known method such as infrared spectroscopy and gas chromatography mass spectrometry.

Optional Components

The polymer layer may include optional components other than the polymer. Examples of the optional components include a polyolefin, other polymers, compatible components, a heat stabilizer, a crosslinking agent, and a lubricant.

Polyolefin

The polymer layer may include a polyolefin.

In the present specification, the “polyolefin” is intended to be a polymer (a polyolefin resin) having a repeating unit derived from an olefin.

The polymer layer preferably includes the liquid crystal polymer and the polyolefin, and more preferably includes the liquid crystal polymer, the polyolefin, and the compatible component.

By using the polyolefin together with the liquid crystal polymer, a resin layer having a dispersed phase formed of the polyolefin can be produced. A method for producing the resin layer having the dispersed phase will be described later.

The polyolefin may be linear or branched. In addition, the polyolefin may have a cyclic structure such as a polycycloolefin.

Examples of the polyolefin include polyethylene, polypropylene (PP), polymethylpentene (TPX and the like manufactured by Mitsui Chemicals, Inc.), hydrogenated polybutadiene, a cycloolefin polymer (COP, Zeonor and the like manufactured by ZEON Corporation), and a cycloolefin copolymer (COC, APEL and the like manufactured by Mitsui Chemicals, Inc.).

The polyethylene may be either high density polyethylene (HDPE) or low density polyethylene (LDPE). In addition, the polyethylene may be linear low density polyethylene (LLDPE).

The polyolefin may be a copolymer of an olefin and a copolymerization component other than the olefin, such as acrylate, methacrylate, styrene, and/or a vinyl acetate-based monomer.

Examples of the polyolefin as the copolymer include a styrene-ethylene/butylene-styrene copolymer (SEBS). SEBS may be hydrogenated.

However, from the viewpoint that the effect of the present invention is more excellent, it is preferable that a copolymerization ratio of the copolymerization component other than the olefin is small, and it is more preferable that the copolymerization component is not included. For example, a content of the copolymerization component is preferably 0% to 40% by mass, and more preferably 0% to 5% by mass with respect to the total mass of the polyolefin.

In addition, the polyolefin is preferably substantially free of a reactive group which will be described below, and a content of the repeating unit having the reactive group is preferably 0% to 3% by mass with respect to the total mass of the polyolefin.

As the polyolefin, polyethylene, COP, or COC is preferable, polyethylene is more preferable, and the low-density polyethylene (LDPE) is still more preferable.

The polyolefins may be used alone or in combination of two or more kinds thereof.

In a case where the polymer layer includes a polyolefin, a content thereof is preferably 0.1% by mass or more, and more preferably 5% by mass or more with respect to the total mass of the polymer layer (or the resin layer) from the viewpoint that the surface property of the polymer layer is more excellent. The upper limit is not particularly limited, but is preferably 50% by mass or less, more preferably 40% by mass or less, and still more preferably 25% by mass or less with respect to the total mass of the polymer layer (or the resin layer) from the viewpoint that the smoothness of the polymer layer is more excellent. In addition, in a case where the content of the polyolefin is 50% by mass or less, a thermal deformation temperature thereof can be easily raised sufficiently and the solder heat resistance can be improved.

Compatible Components

Examples of the compatible component include a polymer (non-reactive compatibilizer) having a moiety having high compatibility or affinity with the liquid crystal polymer and a polymer (reactive compatibilizer) having a reactive group for a phenolic hydroxyl group or a carboxyl group at the terminal of the liquid crystal polymer.

As the reactive group included in the reactive compatibilizer, an epoxy group or a maleic anhydride group is preferable.

As the compatible component, a copolymer having a portion having a high compatibility or a high affinity with the polyolefin is preferable. In addition, in a case where a film includes a polyolefin and a compatible component, a reactive compatibilizer is preferable as the compatible component from the viewpoint that the polyolefin can be finely dispersed.

Furthermore, the compatible component (in particular, the reactive compatibilizer) may form a chemical bond with a component such as a liquid crystal polymer in the polymer layer.

Examples of the reactive compatibilizer include an epoxy group-containing polyolefin-based copolymer, an epoxy group-containing vinyl-based copolymer, a maleic anhydride-containing polyolefin-based copolymer, a maleic anhydride-containing vinyl copolymer, an oxazoline group-containing polyolefin-based copolymer, an oxazoline group-containing vinyl-based copolymer, and a carboxyl group-containing olefin-based copolymer. Among these, the epoxy group-containing polyolefin-based copolymer or the maleic anhydride-grafted polyolefin-based copolymer is preferable.

Examples of the epoxy group-containing polyolefin-based copolymer include an ethylene/glycidyl methacrylate copolymer, an ethylene/glycidyl methacrylate/vinyl acetate copolymer, an ethylene/glycidyl methacrylate/methyl acrylate copolymer, a polystyrene graft copolymer to an ethylene/glycidyl methacrylate copolymer (EGMA-g-PS), a polymethylmethacrylate graft copolymer to an ethylene/glycidyl methacrylate copolymer (EGMA-g-PMMA), and an acrylonitrile/styrene graft copolymer to an ethylene/glycidyl methacrylate copolymer (EGMA-g-AS).

Examples of a commercially available product of the epoxy group-containing polyolefin-based copolymer include Bondfast 2C and Bondfast E manufactured by Sumitomo Chemical Company; Lotadar manufactured by Arkema S.A.; and Modiper A4100 and Modiper A4400 manufactured by NOF Corporation.

Examples of the epoxy group-containing vinyl-based copolymer include a glycidyl methacrylate grafted polystyrene (PS-g-GMA), a glycidyl methacrylate grafted polymethyl methacrylate (PMMA-g-GMA), and a glycidyl methacrylate grafted polyacrylonitrile (PAN-g-GMA).

Examples of the maleic anhydride-containing polyolefin-based copolymer include a maleic anhydride grafted polypropylene (PP-g-MAH), a maleic anhydride grafted ethylene/propylene rubber (EPR-g-MAH), and a maleic anhydride grafted ethylene/propylene/diene rubber (EPDM-g-MAH).

Examples of a commercially available product of the maleic anhydride-containing polyolefin-based copolymer include Orevac G series manufactured by Arkema S.A.; and FUSABOND E series manufactured by The Dow Chemical Company.

Examples of the maleic anhydride-containing vinyl copolymer include a maleic anhydride grafted polystyrene (PS-g-MAH), a maleic anhydride grafted styrene/butadiene/styrene copolymer (SBS-g-MAH), a maleic anhydride grafted styrene/ethylene/butene/styrene copolymer (SEBS-g-MAH and a styrene/maleic anhydride copolymer, and an acrylic acid ester/maleic anhydride copolymer.

Examples of a commercially available product of the maleic anhydride-containing vinyl copolymer include TUFTEC M Series (SEBS-g-MAH) manufactured by Asahi Kasei Corporation.

In addition to those, examples of the compatible component include oxazoline-based compatibilizers (for example, a bisoxazoline-styrene-maleic anhydride copolymer, a bisoxazoline-maleic anhydride-modified polyethylene, and a bisoxazoline-maleic anhydride-modified polypropylene), elastomer-based compatibilizers (for example, an aromatic resin and a petroleum resin), and ethylene glycidyl methacrylate copolymer, an ethylene maleic anhydride ethyl acrylate copolymer, ethylene glycidyl methacrylate-acrylonitrile styrene, acid-modified polyethylene wax, a COOH-modified polyethylene graft polymer, a COOH-modified polypropylene graft polymer, a polyethylene-polyamide graft copolymer, a polypropylene-polyamide graft copolymer, a methyl methacrylate-butadiene-styrene copolymer, acrylonitrile-butadiene rubber, an EVA-PVC-graft copolymer, a vinyl acetate-ethylene copolymer, an ethylene-α-olefin copolymer, a propylene-α-olefin copolymer, a hydrogenated styrene-isopropylene-block copolymer, and an amine-modified styrene-ethylene-butene-styrene copolymer.

In addition, as the compatible component, an ionomer resin may be used.

Examples of such an ionomer resin include an ethylene-methacrylic acid copolymer ionomer, an ethylene-acrylic acid copolymer ionomer, a propylene-methacrylic acid copolymer ionomer, a butylene-acrylic acid copolymer ionomer, a propylene-acrylic acid copolymer ionomer, an ethylene-vinyl sulfonic acid copolymer ionomer, a styrene-methacrylic acid copolymer ionomer, a sulfonated polystyrene ionomer, a fluorine-based ionomer, a telechelic polybutadiene acrylic acid ionomer, a sulfated ethylene-propylene-diene copolymer ionomer, hydrogenated polypentamer ionomer, a polypentamer ionomer, a poly(vinyl pyridium salt) ionomer, a poly(vinyltrimethylammonium salt) ionomer, a poly(vinyl benzyl phosphonium salt) ionomer, a styrene-butadiene acrylic acid copolymer ionomer, a polyurethane ionomer, a sulfated styrene-2-acrylamide-2-methyl propane sulfate ionomer, am acid-amine Ionomer, an aliphatic ionene, and an aromatic ionene.

In a case where the polymer layer includes the compatible component, a content thereof is preferably 0.05% to 30% by mass, more preferably 0.1% to 20% by mass, and particularly preferably 0.5% to 10% by mass with respect to the total mass of the polymer layer (or the resin layer).

Heat Stabilizer

The polymer layer may include a heat stabilizer for the purpose of suppressing thermal oxidative deterioration during film formation through melt extrusion, and improving the flatness and the smoothness of a surface of the polymer layer.

Examples of the heat stabilizer include a phenol-based stabilizer and an amine-based stabilizer, each having a radical scavenging action; a phosphite-based stabilizer and a sulfur-based stabilizer, each having a decomposition action of a peroxide; and a hybrid stabilizer having a radical scavenging action and a decomposition action of a peroxide.

Examples of the phenol-based stabilizer include a hindered phenol-based stabilizer, a semi-hindered phenol-based stabilizer, and a less hindered phenol-based stabilizer.

Examples of a commercially available product of the hindered phenol-based stabilizer include ADK STAB AO-20, AO-50, AO-60, and AO-330 manufactured by ADEKA Corporation; and Irganox 259, 1035, and 1098 manufactured by BASF.

Examples of a commercially available product of the semi-hindered phenol-based stabilizer include ADK STAB AO-80 manufactured by ADEKA Corporation; and Irganox 245 manufactured by BASF.

Examples of a commercially available product of the less hindered phenol-based stabilizer include NOCRAC 300 manufactured by Ouchi Shinko Chemical Industrial Co., Ltd.; and ADK STAB AO-30 and AO-40 manufactured by ADEKA Corporation.

Examples of a commercially available product of the phosphite-based stabilizer include ADK STAB-2112, PEP-8, PEP-36, and HP-10 manufactured by ADEKA Corporation.

Examples of a commercially available product of the hybrid stabilizer include SUMILIZER GP manufactured by Sumitomo Chemical Company.

As the heat stabilizer, the hindered phenol-based stabilizer, the semi-hindered phenol-based stabilizer, or the phosphite-based stabilizer is preferable, and the hindered phenol-based stabilizer is more preferable from the viewpoint that the heat stabilization effect is more excellent. On the other hand, in terms of electrical characteristics, a semi-hindered phenol-based stabilizer or a phosphite-based stabilizer is more preferable.

The heat stabilizers may be used alone or in combination of two or more kinds thereof.

In a case where the polymer layer includes the heat stabilizer, a content thereof is preferably 0.0001% to 10% by mass, more preferably 0.01% to 5% by mass, and particularly preferably 0.1% to 2% by mass with respect to the total mass of the polymer layer (or the resin layer).

Additives

The polymer layer may include an additive other than the components. Examples of the additive include a plasticizer, a lubricant, inorganic and organic particles, and a UV absorbing material.

Examples of the plasticizer include an alkylphthalyl alkyl glycolate compound, a bisphenol compound (bisphenol A, bisphenol F), a phosphoric acid ester compound, a carboxylic acid ester compound, and a polyhydric alcohol. A content of the plasticizer may be 0% to 5% by mass with respect to the total mass of the resin layer.

Examples of the lubricant include a fatty acid ester and a metal soap (for example, a stearic acid inorganic salt). A content of the lubricant may be 0% to 5% by mass with respect to the total mass of the polymer layer (or the resin layer).

The polymer layer may contain inorganic particles and/or organic particles as a reinforcing material, a matting agent, a dielectric constant, or a dielectric loss tangent improving material. Examples of inorganic particles include silica, titanium oxide, barium sulfate, talc, zirconia, alumina, silicon nitride, silicon carbide, calcium carbonate, silicate, glass beads, graphite, tungsten carbide, carbon black, clay, mica, carbon fiber, glass fiber, and metal powder. Examples of the organic particles include crosslinked acryl and crosslinked styrene. A content of the inorganic particles and the organic particles may be 0% to 50% by mass with respect to the total mass of the polymer layer (or the resin layer).

Examples of the UV absorbing material include a salicylate compound, a benzophenone compound, a benzotriazole compound, a substituted acrylonitrile compound, and an s-triazine compound. A content of the UV absorbing material may be 0 to 5% by mass with respect to the total mass of the polymer layer (or the resin layer).

In addition, the polymer layer may include a polymer component other than the polymer having a low standard dielectric loss tangent as long as the effect of the present invention is not impaired.

Examples of the polymer component include thermoplastic polymers such as polyethylene terephthalate, modified polyethylene terephthalate, polycarbonate, polyarylate, polyamide, polyphenylene sulfide, and polyester ether ketone.

A thickness of the polymer layer is preferably 5 to 1,000 μm, more preferably 10 to 500 μm, and still more preferably 20 to 300 μm.

Furthermore, the thickness of the polymer layer is an arithmetic average value of the measured values obtained by measuring the thickness of the polymer layer at any different 100 points from an observation image obtained by observing a cross-section in the thickness direction of a laminate using a scanning electron microscope (SEM).

Adhesive Resin Layer

Since the resin layer has an improved adhesiveness to a metal layer, it is preferable that the resin layer has an adhesive resin layer on a surface in contact with the metal layer.

As the adhesive resin layer, a known adhesive layer used for manufacturing a wiring board such as a copper-clad laminate can be used, and examples thereof include a layer consisting of a cured product of an adhesive composition including a known binder resin.

Binder Resin

The adhesive resin layer preferably includes a binder resin.

Examples of the binder resin include a (meth)acrylic resin, a polyvinyl cinnamate, a polycarbonate, a polyimide, a polyamideimide, a polyesterimide, a polyetherimide, a polyether ketone, a polyether ether ketone, a polyethersulfone, a polysulfone, a polyparaxylene, a polyester, a polyvinyl acetal, a polyvinyl chloride, a polyvinyl acetate, a polyamide, a polystyrene, a polyurethane, a polyvinyl alcohol, a cellulose acylate, a fluororesin, a liquid crystal polymer, a syndiotactic polystyrene, a silicone resin, an epoxy silicone resin, a phenol resin, an alkyd resin, an epoxy resin, a maleic acid resin, a melamine resin, a urea resin, an aromatic sulfonamide, a benzoguanamine resin, a silicone elastomer, an aliphatic polyolefin (for example, polyethylene and polypropylene), and a cyclic olefin copolymer. Among those, the polyimide, the liquid crystal polymer, the syndiotactic polystyrene, or the cyclic olefin copolymer is preferable, and the polyimide is more preferable.

The binder resins may be used alone or in combination of two or more kinds thereof.

A content of the binder resin is preferably 60% to 99.9% by mass, more preferably 70% to 99.0% by mass, and still more preferably 80% to 97.0% by mass with respect to the total mass of the adhesive resin layer.

Reactive Compound

The adhesive resin layer may include a reaction product of a compound having a reactive group. Hereinafter, the compound having a reactive group and a reaction product thereof are also collectively referred to as a “reactive compound”.

The adhesive resin layer preferably includes a reactive compound.

The reactive group contained in the reactive compound is preferably a group capable of reacting with a group that may exist on a surface of the polymer layer (in particular, a group having an oxygen atom, such as a carboxy group and a hydroxy group).

Examples of the reactive group include an epoxy group, an oxetanyl group, an isocyanate group, an acid anhydride group, a carbodiimide group, an N-hydroxyester group, a glyoxal group, an imide ester group, an alkyl halide group, and a thiol group; and at least one group selected from the group consisting of the epoxy group, the acid anhydride group, and the carbodiimide group is preferable, and the epoxy group is more preferable.

Specific examples of the reactive compound having an epoxy group include aromatic glycidylamine compounds (for example, N,N-diglycidyl-4-glycidyloxyaniline, 4,4′-methylenebis(N,N-diglycidylaniline), N,N-diglycidyl-o-toluidine, and N,N,N′,N′-tetraglycidyl-m-xylene diamine, 4-t-butylphenylglycidyl ether), aliphatic glycidylamine compounds (for example, 1,3-bis(diglycidylaminomethyl)cyclohexane), and aliphatic glycidyl ether compounds (for example, sorbitol polyglycidyl ether). Among those, the aromatic glycidylamine compounds are preferable from the viewpoint that the effect of the present invention is more excellent.

Specific examples of the reactive compound having an acid anhydride group include tetracarboxylic dianhydrides (for example, 3,3′,4,4′-benzophenone tetracarboxylic dianhydride, 3,3′,4,4′-biphenyltetracarboxylic dianhydride, pyromellitic dianhydride, 2,3,3′,4′-biphenyltetracarboxylic dianhydride, oxydiphthalic dianhydride, diphenylsulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, bis(3,4-dicarboxyphenyl)methane dianhydride, 2,2-bis(3,4-dicarboxyphenyl)propane dianhydride, p-phenylenebis(trimellitic acid monoester anhydride), p-biphenylenebis(trimellitic acid monoester anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis [(3,4-dicarboxyphenoxy)phenyl]propane dianhydride, 2,3,6,7-naphthalenetetracarboxylic dianhydride, 1,4,5,8-naphthalenetetracarboxylic dianhydride, and 4,4′-(2,2-hexafluoroisopropyridene)diphthalic dianhydride).

Specific examples of the reactive compound having a carbodiimide group include monocarbodiimide compounds (for example, dicyclohexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide, di-β-naphthylcarbodiimide, N,N′-di-2,6-diisopropylphenylcarbodiimide), and polycarbodiimide compounds (for example, the compounds described in U.S. Pat. No. 2,941,956A, JP1972-033279B (JP-547-033279B), J. Org. Chem. 28, p. 2069-2075 (1963), Chemical Review 1981, 81, No. 4, p. 619-621, and the like).

Examples of a commercially available product of the reactive compound having a carbodiimide group include Carbodilite (registered trademark) HMV-8CA, LA-1, and V-03 (both manufactured by Nisshinbo Chemical Inc.), and Stabaxol (registered trademark) P, P100, and P400 (all manufactured by Rhein Chemie Japan Ltd.), and Stabilizer 9000 (trade name, manufactured by Rhein Chemie Corporation).

The number of the reactive groups contained in the reactive compound is 1 or more, but is preferably 3 or more from the viewpoint that the adhesiveness of the metal layer is more excellent.

The number of the reactive groups contained in the reactive compound is preferably 6 or less, more preferably 5 or less, and still more preferably 4 or less from the viewpoint that the effect of the present invention is more excellent.

A reaction product of the compound having a reactive group is not particularly limited as long as it is a compound derived from the compound having a reactive group, and examples thereof include a reaction product obtained by a reaction between the reactive group of the compound having a reactive group and a group including an oxygen atom present on a surface of the polymer film.

The reactive compounds may be used alone or in combination of two or more kinds thereof.

A content of the reactive compound is preferably 0.1% to 40% by mass, more preferably 1% to 30% by mass, and still more preferably 3% to 20% by mass with respect to the total mass of the adhesive resin layer from the viewpoint that the effect of the present invention and the adhesiveness to the metal layer are excellent with a good balance.

The adhesive resin layer may include a component (hereinafter also referred to as an “additive”) other than the reactive compound and the binder resin.

Examples of the additive include an inorganic filler, a curing catalyst, and a flame retardant.

A content of the additive is preferably 0.1% to 40% by mass, more preferably 1% to 30% by mass, and still more preferably 3% to 20% by mass with respect to the total mass of the adhesive resin layer.

Residual Solvent

The adhesive resin layer may include a solvent.

In the present specification, the “solvent” is intended to be an organic solvent, and does not include water. The “organic solvent” means an organic compound that is liquid at 25° C. and under atmospheric pressure.

Examples of the solvent included in the adhesive resin layer include an organic solvent included as a solvent in the composition for forming an adhesive resin layer which will be described later.

From the viewpoints that the effect of the present invention is more excellent and the generation of bubbles due to the residual solvent can be further suppressed, a content of the solvent in the adhesive resin layer is preferably 500 ppm by mass or less, more preferably 300 ppm by mass or less, still more preferably 200 ppm by mass or less, and particularly preferably 50 ppm by mass or less with respect to the total mass of the adhesive resin layer. The lower limit value is not particularly limited, and may be 0 ppm by mass or more, but is preferably 0.1 ppm by mass or more, and more preferably 5 ppm by mass or more with respect to the total mass of the adhesive resin layer.

The content of the solvent in the adhesive resin layer can be adjusted by changing the drying temperature, the drying air velocity, and/or the drying time.

Furthermore, the content of the solvent included in the adhesive resin layer tends not to fluctuate even in a case where the laminate is stored in an environment of 23° C. and 1 atm, in particular, in a solvent such as a ketone compound.

Physical Properties of Adhesive Resin Layer

Thickness

From the viewpoint that the effect of the present invention is more excellent, a thickness of the adhesive resin layer is preferably 1 μm or less, more preferably 0.8 μm or less, still more preferably 0.7 μm or less, and particularly preferably 0.6 μm or less. The lower limit is not particularly limited, but is preferably 0.05 μm or more, more preferably 0.1 μm or more, and still more preferably 0.2 μm or more from the viewpoint that the adhesiveness between the metal layer and the resin layer is more excellent.

In addition, a ratio of the thickness of the adhesive resin layer to the thickness of the polymer layer is preferably 0.1% to 2%, and more preferably 0.2% to 1.6 from the viewpoint that the effect of the present invention and the adhesiveness to the metal layer are excellent with a good balance.

Furthermore, the thickness of the adhesive resin layer is a thickness per one adhesive resin layer.

The thickness of the adhesive resin layer can be measured according to the method for measuring a thickness of the polymer layer.

Elastic Modulus

An elastic modulus of the adhesive resin layer is preferably 0.8 GPa or more, more preferably 1.0 GPa or more, still more preferably 1.1 GPa or more, and particularly preferably 1.2 GPa or more from the viewpoint that the adhesiveness with the metal layer is more excellent. The upper limit value of the elastic modulus of the adhesive resin layer is not particularly limited, and is, for example, 5 GPa or less.

The elastic modulus of the adhesive resin layer is an indentation elastic modulus measured according to ISO14577, and a specific measurement method therefor is described in the Example column which will be described later.

The elastic modulus of the adhesive resin layer can be adjusted by changing the ratio of the binder resin and the reactive compound.

Physical Properties of Resin Layer

Thickness

A thickness of the resin layer is preferably 5 to 1,000 μm, more preferably 10 to 500 μm, and still more preferably 20 to 300 μm.

The thickness of the resin layer can be measured according to the method for measuring a thickness of the polymer layer.

Dispersed Phase

In a case where the resin layer includes a polyolefin, it is preferable that the polyolefin forms a dispersed phase in the resin layer.

The dispersed phase corresponds to an island portion in a resin layer having a so-called sea-island structure inside.

A method of forming the sea-island structure in the resin layer and allowing the polyolefin to exist as a dispersed phase is not limited, and for example, a dispersed phase of a polyolefin can be formed by adjusting each of the contents of the liquid crystal polymer and the polyolefin included in the resin layer to the above-mentioned suitable contents.

An average dispersion diameter of the dispersed phase is preferably 0.001 to 50.0 μm, more preferably 0.005 to 20.0 μm, and still more preferably 0.01 to 10.0 μm from the viewpoint that the smoothness is more excellent.

The dispersed phase is preferably flat, and a smooth surface of the smooth dispersed phase is preferably substantially parallel to the resin layer.

In addition, from the viewpoint of reducing the anisotropy of the resin layer, the smooth surface of the smooth dispersed phase is preferably substantially circular in a case of being observed from a direction perpendicular to the surface of the resin layer. It is considered that in a case where such a dispersed phase is dispersed in the resin layer, a dimensional change which occurs in the resin layer can be absorbed, and more excellent surface properties and smoothness can be realized.

The average dispersion diameter of the dispersed phase and the shape of the dispersed phase are obtained from an observation image obtained by observing a cross-section of the laminate in the thickness direction using a scanning electron microscope (SEM). A detailed method for measuring the average dispersion diameter of the dispersed phase will be described in the Example column which will be described later.

The laminate may have a layer other than the resin layer and the metal layer, as necessary. Examples of the other layer include a rust preventive layer and a heat resistant layer.

Physical Properties of Laminate

A peel strength between the resin layer and the metal layer in the laminate is preferably more than 0.5 kN/m, more preferably 0.55 kN/m or more, still more preferably 0.6 kN/m or more, and particularly preferably 0.65 kN/m or more. The more the peel strength, the better the adhesiveness between the resin layer and the metal layer.

The upper limit value of the peel strength of the laminate is not particularly limited, and may be 1.0 or more.

A method for measuring the peel strength of the laminate will be described in the Example column which will be described later.

Method for Producing Laminate

A method for producing a laminate is not particularly limited, and examples thereof include a method including a step of manufacturing a resin film using a composition including components constituting a resin layer (hereinafter also referred to as a “step 1”), and a step of laminating the resin film manufactured in the step 1 and a metal foil consisting of a metal constituting a metal layer, and then compressing the resin film and the metal foil under high temperature conditions to produce a laminate having the resin layer and the metal layer (hereinafter also referred to as a “step 2”).

Step 1

A method for manufacturing the resin film is not particularly limited, and examples thereof include a method having at least a step of manufacturing a polymer film using a composition including the components constituting the polymer layer (hereinafter also referred to as a “step 1A”), and depending on cases, further having a step of adhering a composition for forming an adhesive resin layer on the polymer film manufactured in the step 1A to manufacture a polymer film (resin film) with an adhesive resin layer having the polymer film and the adhesive resin layer (hereinafter also referred to as a “step 1B”).

Step 1A

The step 1A of manufacturing the polymer film is not particularly limited, but examples thereof include a method having a pelletizing step of kneading the above-mentioned components constituting the polymer layer to obtain pellets, and a film forming step of forming a resin film using the pellets.

Hereinafter, each step will be described by taking as an example a case of manufacturing a polymer film including a liquid crystal polymer.

Pelletizing Step

(1) Form of Raw Material

As the polymer such as a liquid crystal polymer used for the film formation, pellet-shaped, flake-shaped, or powder-shaped ones can be used as they are, but for the purpose of stabilizing the film formation or uniformly dispersing an additive (which means a component other than the liquid crystal polymer; the same applies hereinafter), it is preferable to use pellets obtained by kneading one or more kinds of raw materials (meaning at least one of a polymer or an additive; the same applies hereinafter) using an extruder, and performing pelletization before use.

(2) Drying or Drying Alternative by Vent

Before pelletizing, it is preferable to dry the liquid crystal polymer and the additive in advance. As a drying method, a method of circulating heated air having a low dew point, a method of dehumidifying by vacuum drying, and the like are used. In particular, in a case of a resin which is easily oxidized, vacuum drying or drying using an inert gas is preferable.

(3) Method for Supplying Raw Materials

A method for supplying raw materials may be a method in which raw materials are mixed in advance before being made into kneaded pellets and then supplied, a method in which raw materials are separately supplied into the extruder so as to be in a fixed ratio, or a method of a combination of both.

(4) Atmosphere During Extrusion

In a case of melt extrusion, to the extent that uniform dispersion is not hindered, it is preferable to prevent thermal and oxidative deterioration as much as possible, and it is also effective to reduce an oxygen concentration by reducing the pressure using a vacuum pump or inflowing an inert gas. These methods may be carried out alone or in combination.

(5) Temperature

A kneading temperature is preferably set to be equal to or lower than a thermal decomposition temperature of the liquid crystal polymer and the additive, and is preferably set to a low temperature as much as possible within a range in which a load of the extruder and a decrease in uniform kneading property are not a problem.

(6) Pressure

A kneading resin pressure during pelletization is preferably 0.05 to 30 MPa. In a case of a resin in which coloration or gel is likely to be generated due to shearing, it is preferable to apply an internal pressure of approximately 1 to 10 MPa to the inside of the extruder to fill the inside of the biaxial screw extruder with the resin raw material.

(7) Pelletizing Method

As a pelletizing method, a method of solidifying a noodle-shaped extrusion and then cutting the extrusion is generally used, but the pelletization may be performed by an under water cut method for cutting while directly extruding from a mouthpiece into water after melting with the extruder, or a hot cut method for cutting while still hot.

(8) Pellet Size

A pellet size is preferably 1 to 300 mm² in a cross-sectional area and 1 to 30 mm in a length, and more preferably 2 to 100 mm² in a cross-sectional area and 1.5 to 10 mm in a length.

Drying

(1) Purpose of Drying

Before a molten film formation, it is preferable to reduce a moisture and a volatile fraction in the pellets, and it is effective to dry the pellets. In a case where the pellets include a moisture or a volatile fraction, not only appearance is deteriorated due to the inclusion of bubbles in the polymer film or the decrease in a haze, but also physical properties may be deteriorated due to a molecular chain breakage of the liquid crystal polymer, or roll contamination may occur due to generation of monomers or oligomers. In addition, depending on the type of the liquid crystal polymer used, it may be possible to suppress formation of an oxidative crosslinked substance during molten film formation by removing dissolved oxygen by the drying.

(2) Drying Method and Heating Method

In terms of drying efficiency and economical efficiency, a dehumidifying hot air dryer is generally used as a drying method, but the drying method is not particularly limited as long as a desired moisture content can be obtained. In addition, there is no problem in selecting a more appropriate method according to characteristics of the physical properties of the liquid crystal polymer.

Examples of a heating method include pressurized steam, heater heating, far-infrared irradiation, microwave heating, and a heat medium circulation heating method.

Film Forming Step

Hereinafter, the film forming step will be described.

(1) Extrusion Conditions

Drying of Raw Materials

In the melt plasticization step for pellets using an extruder, it is preferable to reduce a moisture and a volatile fraction in the pellets as in the pelletizing step, and it is effective to dry the pellets.

Raw Material Supply Method

In a case where there are multiple types of raw materials (pellets) input from the extruder supply port, the raw materials may be mixed in advance (premix method), may be separately supplied into the extruder in a fixed ratio, or may be a combination of the both. In addition, in order to stabilize the extrusion, it is generally practiced to reduce a fluctuation of the temperature and a bulk specific density of the raw material charged from the supply port. Moreover, in terms of thermoplastic efficiency, a raw material temperature is preferably high as long as it does not block a supply port by pressure-sensitive adherence, and in a case where the raw material is in an amorphous state, the raw material temperature is preferably {Glass transition temperature (Tg) (° C.)-150° C.} to {Tg (° C.)-1° C.}, and in a case where the raw material is a crystalline resin, the raw material temperature is preferably {Melting point (Tm) (° C.)-150° C.} to {Tm (° C.)-1° C.}, and the raw material is heated or kept warm. In addition, in terms of thermoplastic efficiency, the bulk specific gravity of the raw material is preferably 0.3 times or more, and more preferably 0.4 times or more in a case of a molten state. In a case where the bulk specific density of the raw material is less than 0.3 times the specific gravity in the molten state, it is also preferable to perform a processing treatment such as compressing the raw material into pseudo-pellets.

Atmosphere During Extrusion

As for the atmosphere during melt extrusion, it is necessary to prevent heat and oxidative deterioration as much as possible within a range that does not hinder uniform dispersion as in the pelletizing step. It is also effective to inject an inert gas (nitrogen or the like), reduce the oxygen concentration in the extruder by using a vacuum hopper, and provide a vent port in the extruder to reduce the pressure by a vacuum pump. These depressurization and injection of the inert gas may be carried out independently or in combination.

Rotation Speed

A rotation speed of the extruder is preferably 5 to 300 rpm, more preferably 10 to 200 rpm, and still more preferably 15 to 100 rpm. In a case where the rotation rate is set to the lower limit value or more, the retention time is shortened, the decrease in molecular weight can be suppressed due to thermal deterioration, and discoloration can be suppressed. In a case where the rotation rate is set to the upper limit value or less, a breakage of a molecular chain due to shearing can be suppressed, and a decrease in molecular weight and an increase in generation of crosslinked gel can be suppressed. It is preferable to select appropriate conditions for the rotation speed from the viewpoints of both uniform dispersibility and thermal deterioration due to extension of the retention time.

Temperature

A barrel temperature (supply unit temperature T₁° C., compression unit temperature T₂° C., and measuring unit temperature T₃° C.) is generally determined by the following method. In a case where the pellets are melt-plasticized at a target temperature T° C. by the extruder, the measuring unit temperature T₃ is set to T±20° C. in consideration of the shear calorific value. At this time, T₂ is set within a range of T₃±20° C. in consideration of extrusion stability and thermal decomposability of the resin. Generally, T₁ is set to {T₂ (° C.)-5° C.} to {T₂ (° C.)-150° C.}, and the optimum value of T₁ is selected in terms of ensuring a friction between the resin and the barrel, which is a driving force (feed force) for feeding the resin, and preheating at the feed portion. In a case of a normal extruder, it is possible to subdivide each zone of T₁ to T₃ and set the temperature, and by performing settings such that the temperature change between each zone is gentle, it is possible to make it more stable. At this time, T is preferably set to be equal to or lower than the thermal deterioration temperature of the resin, and in a case where the thermal deterioration temperature is exceeded due to the shear heat generation of the extruder, it is generally performed to positively cool and remove the shear heat generation. In addition, in order to achieve both improved dispersibility and thermal deterioration, it is also effective to melt and mix a first half part in the extruder at a relatively high temperature and lower the resin temperature in a second half part.

Pressure

A resin pressure in the extruder is generally 1 to 50 MPa, and in terms of extrusion stability and melt uniformity, the resin pressure is preferably 2 to 30 MPa, and more preferably 3 to 20 MPa. In a case where the pressure in the extruder is 1 MPa or more, a filling rate of the melting in the extruder is sufficient, and therefore, the destabilization of the extrusion pressure and the generation of foreign matter due to the generation of retention portions can be suppressed. In addition, in a case where the pressure in the extruder is 50 MPa or less, it is possible to suppress the excessive shear stress received in the extruder, and therefore, thermal decomposition due to an increase in the resin temperature can be suppressed.

Retention Time

A retention time in the extruder (retention time during film formation) can be calculated from a volume of the extruder portion and a discharge capacity of the polymer, as in the pelletizing step. The retention time is preferably 10 seconds to 60 minutes, more preferably 15 seconds to 45 minutes, and still more preferably 30 seconds to 30 minutes. In a case where the retention time is 10 seconds or more, the melt plasticization and the dispersion of the additive are sufficient. In a case where the retention time is 30 minutes or less, it is preferable in that resin deterioration and discoloration of the resin can be suppressed.

Filtration

Type, Purpose of Installation, and Structure

It is generally used to provide a filtration equipment at the outlet of the extruder in order to prevent damage to the gear pump due to foreign matter included in the raw material and to extend the life of the filter having a fine pore size installed downstream of the extruder. It is preferable to perform so-called breaker plate type filtration in which a mesh-shaped filtering medium is used in combination with a reinforcing plate having a high opening ratio and having strength.

Mesh Size and Filtration Area

A mesh size is preferably 40 to 800 mesh, more preferably 60 to 700 mesh, and still more preferably 100 to 600 mesh. In a case where the mesh size is 40 mesh or more, it is possible to sufficiently suppress foreign matter from passing through the mesh. In addition, in a case where the mesh is 800 mesh or less, the improvement of the filtration pressure increase speed can be suppressed and the mesh replacement frequency can be reduced. In addition, in terms of filtration accuracy and strength maintenance, a plurality of types of filter meshes having different mesh sizes are often superimposed and used. Moreover, since the filtration opening area can be widened and the strength of the mesh can be maintained, the filter mesh may also be reinforced by using a breaker plate. An opening ratio of the breaker plate used is often 30% to 80% in terms of filtration efficiency and strength.

In addition, a screen changer with the same diameter as the barrel diameter of the extruder is often used, but in order to increase the filtration area, a larger diameter filter mesh is used by using a tapered pipe, or a plurality of breaker plates is also sometimes used by branching a flow channel. The filtration area is preferably selected with a flow rate of 0.05 to 5 g/cm² per second as a guide, more preferably 0.1 to 3 g/cm², and still more preferably 0.2 to 2 g/cm².

By capturing foreign matter, the filter is clogged and the filter pressure rises. At that time, it is necessary to stop the extruder and replace the filter, but a type in which the filter can be replaced while continuing extrusion can also be used. In addition, as a measure against an increase in the filtration pressure due to the capture of foreign matter, a measure having a function of lowering the filtration pressure by cleaning and removing the foreign matter trapped in the filter by reversing the flow channel of the polymer can also be used.

Die

Type, Structure, and Material

The molten resin from which foreign matters have been removed by filtration and in which the temperature has been made uniform by a mixer is continuously sent to the die. The die is not particularly limited as long as it is designed so that the retention of the molten resin is small, and any type of a T die, a fishtail die, or a hanger coat die, commonly used, can also be used. Among these, the hanger coat die is preferable in terms of thickness uniformity and less retention.

Multilayer Film Formation

A single-layer film forming apparatus having a low equipment cost is used for manufacturing a polymer film. In addition, in order to produce a polymer film having a functional layer such as an adhesive resin layer, a surface protective layer, a pressure-sensitive adhesive layer, an easy adhesion layer, and/or an antistatic layer, a multilayer film forming apparatus may be used. Specific examples thereof include a method of performing multilayering using a multilayer feed block and a method of using a multi-manifold die. It is preferable to laminate the functional layer thinly on the surface layer, but the layer ratio is not particularly limited.

Cast

The film forming step preferably includes a step of supplying a raw material resin in a molten state from the supply unit and a step of landing the raw material resin in the molten state on a cast roll to form a film. The molten raw material resin may be cooled and solidified, and wound as it is as a polymer film, or it may be passed between a pair of pressing compression surfaces and continuously pressed to form a film.

At this time, the unit for supplying the raw material resin (melt) in a molten state is not particularly limited. For example, as a specific unit for supplying the melt, an extruder which melts the raw material resin including the liquid crystal polymer and extrudes it into a film may be used, an extruder and a die may be used, or the raw material resin may be once solidified into a film and then molten by a heating unit to form a melt, which may be supplied to the film forming step.

In a case where the molten resin extruded from the die into a sheet is pressed by a device having a pair of pressing compression surfaces, not only can the surface morphology of the compression surface be transferred to a surface of the polymer film, but aligning properties can be controlled by imparting elongation deformation to the composition including the liquid crystal polymer.

Film Forming Method and Type

Among the methods for molding the raw material resin in a molten state into a film, it is preferable to pass between two rolls (for example, a touch roll and a chill roll) from the viewpoint that a high pinching pressure can be applied and the surface shape of the polymer film is excellent. Furthermore, in the present specification, in a case where a plurality of cast rolls for transporting the melt are provided, the cast roll closest to a supply unit (for example, a die) for the most upstream liquid crystal polymer is referred to as a chill roll. In addition, a method of pressing metal belts with each other or a method of combining a roll and a metal belt can also be used. In addition, in some cases, in order to improve the adhesiveness with rolls or metal belts, a film forming method such as a static electricity application method, an air knife method, an air chamber method, and a vacuum nozzle method can be used in combination on a cast drum.

In addition, in a case of obtaining a polymer film having a multilayer structure, it is preferable to obtain the polymer film by pressing a raw material resin including a molten polymer extruded from a die in multiple layers, but it is also possible to obtain a polymer film having a multilayer structure by introducing a polymer film having a single-layer structure into a pressing portion in the same manner as for molten laminating. In addition, at this time, polymer films having different inclined structures in the thickness direction can be obtained by changing the circumferential speed difference or the alignment axis direction of the pressing portion, and polymer films having three or more layers can be obtained by performing this step several times.

Furthermore, the touch roll may be periodically vibrated in the TD direction in a case of pressing to give deformation.

Temperature of Molten Polymer

In terms of the improvement of the moldability of the liquid crystal polymer and the suppression of deterioration, a discharge temperature (resin temperature at an outlet of the supply unit) is preferably (Tm of liquid crystal polymer−10)° C. to (Tm of liquid crystal polymer+40)° C. As a guide for the melt viscosity, 50 to 3,500 Pas is preferable.

It is preferable that the cooling of the molten polymer between the air gaps is as small as possible, and it is preferable to reduce a temperature drop due to the cooling by taking measures such as increasing the film forming speed and shortening the air gap.

Temperature of Touch Roll

A temperature of the touch roll is preferably set to Tg or less of the liquid crystal polymer. In a case where the temperature of the touch roll is Tg or less of the liquid crystal polymer, pressure-sensitive adhesion of the molten polymer to the roll can be suppressed, and therefore, the polymer film appearance is improved. For the same reason, the chill roll temperature is preferably set to Tg or less of the liquid crystal polymer.

Film Formation Procedure

In the film forming step, it is preferable to perform the film formation by the following procedure in terms of the film forming step and the stabilization of quality.

The molten polymer discharged from the die is landed on a cast roll to form a film, which is then cooled and solidified and wound up as a polymer film.

In a case of pressing the molten polymer, the molten polymer is passed between the first compression surface and the second compression surface set at a predetermined temperature, and then is cooled and solidified and wound up as a polymer film.

Stretching Step, Thermal Relaxation Treatment, and Thermal Fixation Treatment

Furthermore, after forming an unstretched polymer film by the method, the unstretched polymer film may be continuously or discontinuously stretched and/or subjected to a thermal relaxation treatment or a thermal fixation treatment. For example, each step can be carried out by the combination of the following (a) to (g). In addition, the order of the machine-direction stretching and the cross-direction stretching may be reversed, each step of the machine-direction stretching and the cross-direction stretching may be performed in multiple stages, and each step of the machine-direction stretching and the cross-direction stretching may be combined with diagonal stretching or simultaneous biaxial stretching.

(a) Cross-direction stretching

(b) Cross-direction stretching→Thermal relaxation treatment

(c) Machine-direction stretching

(d) Machine-direction stretching→Thermal relaxation treatment

(e) Machine-direction (cross-direction) stretching→Cross-direction (machine-direction) stretching

(f) Machine-direction (cross-direction) stretching→Cross-direction (machine-direction) stretching→Thermal relaxation treatment

(g) Cross-direction stretching→Thermal relaxation treatment→Machine-direction stretching→Thermal relaxation treatment

Hereinafter, the unstretched polymer film and the stretched polymer film are collectively referred to simply as a “film”.

Machine-Direction Stretching

The machine-direction stretching can be achieved by making the circumferential speed on the outlet side faster than the circumferential speed on the inlet side while heating between the two pairs of rolls. From the viewpoint of suppressing a curl, it is preferable that the film temperatures are the same on the front and back surfaces of the film to be subjected to a stretching treatment, but in a case where optical characteristics are controlled in the thickness direction, the stretching can be performed at different temperatures on the front and back surfaces. Furthermore, the stretching temperature herein is defined as a temperature on the lower side of the film surface. The machine-direction stretching step may be carried out in either one step or multiple steps. The unstretched film is often preheated by passing it through a temperature-controlled heating roll, but in some cases, a heater can be used to heat the unstretched film. In addition, a ceramic roll or the like having improved adhesiveness can also be used in order to prevent the film from being subjected to a stretching treatment from pressure-sensitive adherence to the roll.

Cross-Direction Stretching

As the cross-direction stretching step, normal cross-direction stretching can be adopted. That is, examples of the normal cross-direction stretching include a stretching method in which both ends in the width direction of the film to be subjected to a stretching treatment are gripped with clips, and the clips are widened while being heated in an oven using a tenter. With regard to the cross-direction stretching step, for example, methods described in JP1987-035817U (JP-S62-035817U), JP2001-138394A, JP1998-249934A (JP-H10-249934A), JP1994-270246A (JP-H06-270246A), JP1992-030922U (JP-H04-030922U), and JP1987-152721A (JP-562-152721A) can be used, and these methods are herein incorporated by reference.

A stretching ratio (cross-direction stretching ratio) in the width direction of the film in the cross-direction stretching step is preferably 1.2 to 6 times, more preferably 1.5 to 5 times, and still more preferably 2 to 4 times. In addition, the cross-direction stretching ratio is preferably larger than the stretching ratio of the machine-direction stretching in a case where the machine-direction stretching is performed.

A stretching temperature in the cross-direction stretching step can be controlled by blowing air at a desired temperature into a tenter. The film temperatures may be the same or different on the front and back surfaces for the same reason as in the machine-direction stretching. The stretching temperature used herein is defined as a temperature on the lower side of the film surface. The cross-direction stretching step may be carried out in one step or in multiple steps. In addition, in a case of performing cross-direction stretching in multiple stages, the cross-direction stretching may be performed continuously or intermittently by providing a zone in which widening is not performed. For such the cross-direction stretching, in addition to the normal cross-direction stretching in which a clip is widened in the width direction in a tenter, a stretching method as below, in which a clip is widened by gripping, can also be applied.

Diagonal Stretching

In the diagonal stretching step, the clips are widened in the cross-direction in the same manner as in the normal cross-direction stretching, but can be stretched diagonally by changing a transportation speed of the left and right clips. As the diagonal stretching step, for example, the methods described in JP2002-022944A, JP2002-086554A, JP2004-325561A, JP2008-023775A, and JP2008-110573A can be used.

Simultaneous Biaxial Stretching

The simultaneous biaxial stretching is a treatment in which clips are widened in the cross-direction, and simultaneously stretched or contracted in the machine direction, in a similar manner to the normal cross-direction stretching. As the simultaneous biaxial stretching, for example, the methods described in JP1980-093520U (JP-555-093520U), JP1988-247021A (JP-S63-247021A), JP1994-210726A (JP-H06-210726A), JP1994-278204A (JP-H06-278204A), JP2000-334832A, JP2004-106434A, JP2004-195712A, JP2006-142595A, JP2007-210306A, JP2005-022087A, JP2006-517608A, and JP2007-210306A can be used.

Heat Treatment to Improve Bowing (Axis Misalignment)

Since the end part of the film is gripped by the clip in the cross-direction stretching step, the deformation of the film due to a thermal shrinkage stress generated during a heat treatment is large at the center of the film and is small at the end parts, and as a result, the characteristics in the width direction can be distributed. In a case where a straight line is drawn along the cross-direction on a surface of the film before the heat treatment step, the straight line on the surface of the film after the heat treatment step is an arcuate shape in which the center portion is recessed toward the downstream side. This phenomenon is called a bowing phenomenon, and is a cause that disturbs isotropy and widthwise uniformity of the film.

With an improvement method therefor, it is possible to reduce a variation in an alignment angle due to the bowing by performing preheating before the cross-direction stretching or by performing the thermal fixation after the stretching. The preheating and the thermal fixation may be performed, but it is more preferable to perform the both. It is preferable to perform the preheating and the thermal fixation by gripping with a clip, that is, it is preferable to perform the preheating and the thermal fixation continuously with the stretching.

The preheating temperature is preferably higher than the stretching temperature by approximately 1° C. to 50° C., more preferably higher than 2° C. to 40° C., and still more preferably higher than 3° C. to 30° C. The preheating time is preferably 1 second to 10 minutes, more preferably 5 seconds to 4 minutes, and still more preferably 10 seconds to 2 minutes.

During the preheating, it is preferable to keep the width of the tenter almost constant. The term “almost” as mentioned herein refers to ±10% of the width of the unstretched film.

The thermal fixation temperature is preferably 1° C. to 50° C. lower than the stretching temperature, more preferably lower than 2° C. to 40° C., and still more preferably lower than 3° C. to 30° C. The thermal fixation temperature is preferably a temperature no higher than stretching temperature and no higher than the Tg of the liquid crystal polymer.

The thermal fixation time is preferably 1 second to 10 minutes, more preferably 5 seconds to 4 minutes, and still more preferably 10 seconds to 2 minutes. During thermal fixation, it is preferable to keep the width of the tenter almost constant. The term “almost” as mentioned herein means 0% (the same width as the tenter width after stretching) to −30% (30% smaller than the tenter width after stretching=reduced width) of the tenter width after the completion of stretching. Examples of other known methods include the methods described in JP1989-165423A (JP-H01-165423A), JP1991-216326A (JP-H03-216326A), JP2002-018948A, and JP2002-137286A.

Thermal Relaxation Treatment

After the stretching step, a thermal relaxation treatment in which the film is heated to shrink the film may be performed. By performing the thermal relaxation treatment, the thermal shrinkage rate of the polymer film at the time of using the laminate can be reduced. It is preferable that the thermal relaxation treatment is carried out at at least one timing of a time after film formation, a time after machine-direction stretching, or a time after cross-direction stretching.

The thermal relaxation treatment may be continuously performed online after the stretching, or may be performed offline after winding after the stretching. Examples of the temperature of the thermal relaxation treatment include a temperature from a glass transition temperature of the liquid crystal polymer Tg to a melting point Tm. In a case where there is a concern about oxidative deterioration of the polymer film, the thermal relaxation treatment may be performed in an inert gas such as a nitrogen gas, an argon gas, and a helium gas.

Preheating Treatment

In the step 1A, it is preferable to perform a preheating treatment in which the film is heated while fixing the film width after carrying out cross-direction stretching of the film from the viewpoint that the thermal dimensional stability is more excellent, more specifically, the shrinkage of the film during the heating in a later step can be suppressed.

In the preheating treatment, a heat treatment is performed while fixing the film width by a fixing method such as gripping both ends of a film in a width direction with clips. The film width after the preheating treatment is preferably 85% to 105%, and more preferably 95% to 102% with respect to the film width before the preheating treatment.

The heating temperature in the preheating treatment is preferably {Tm-200}° C. or higher, more preferably {Tm-100}° C. or higher, and still more preferably {Tm-50}° C. or higher, with the melting point of the liquid crystal polymer being taken as Tm (° C.). The upper limit of the heating temperature in the preheating treatment is preferably {Tm}° C. or lower, more preferably {Tm-2}° C. or lower, and still more preferably {Tm-5}° C. or lower.

Alternatively, the heating temperature in the preheating treatment is preferably 240° C. or higher, more preferably 255° C. or higher, and still more preferably 270° C. or higher. The upper limit is preferably 315° C. or lower, and more preferably 310° C. or lower.

Examples of the heating unit used for the preheating treatment include a hot air dryer and an infrared heater, and the infrared heater is preferable since a film having a desired melting peak surface area can be produced in a short time. In addition, as the heating unit, pressurized steam, microwave heating, and a heat medium circulation heating method may be used.

A treatment time for the preheating treatment can be appropriately adjusted according to the type of the liquid crystal polymer, the heating unit, and the heating temperature, and in a case where the infrared heater is used, the treatment time is preferably 1 to 120 seconds, and more preferably 3 to 90 seconds. In addition, in a case where the hot air dryer is used, the treatment time is preferably 0.5 to 30 minutes, and more preferably 1 to 10 minutes.

Surface Treatment

Since the adhesiveness between the polymer film and a metal layer such as a copper foil and a copper plating layer, or another layer can be further improved, it is preferable to subject the polymer film to a surface treatment. Examples of the surface treatment include a glow discharge treatment, an ultraviolet irradiation treatment, a corona treatment, a flame treatment, and an acid or alkali treatment. The glow discharge treatment as mentioned herein may be a treatment with a low-temperature plasma generated in a gas at a low pressure ranging from 10⁻³ to 20 Torr, and is preferably a plasma treatment under atmospheric pressure.

The glow discharge treatment is performed using a plasma-excited gas. The plasma-excited gas refers to a gas that is plasma-excited under the above-described conditions, and examples thereof include fluorocarbons such as argon, helium, neon, krypton, xenon, nitrogen, carbon dioxide, and tetrafluoromethane, and mixtures of these.

It is also useful to subject the polymer film to an aging treatment at a temperature which is no higher than the Tg of the liquid crystal polymer in order to improve the mechanical properties, thermal dimensional stability, or winding shape of the wound polymer film.

In addition, with regard to the polymer film, the smoothness of the polymer film may be further improved by further performing a step of pressing the polymer film with a heating roll and/or a step of stretching the polymer film after performing the film forming step.

In the manufacturing method, the case where the polymer film is a single layer is described, but the polymer film may have a laminated structure in which a plurality of layers are laminated.

Step 1B

In a case where a laminate having a resin layer consisting of a polymer layer and an adhesive resin layer as the resin layer is manufactured, it is preferable to perform a step 1B in which a composition for forming an adhesive resin layer is adhered to the polymer film manufactured in the step 1A to manufacture a polymer film with an adhesive resin layer having a polymer film and an adhesive resin layer.

Examples of the step 1B include a step in which a composition for forming an adhesive resin layer is applied onto at least one surface of the polymer film manufactured in the step 1A, and the coating film is dried and/or cured, as necessary, to form an adhesive resin layer on the polymer film.

Examples of the composition for forming an adhesive resin layer include a composition including components constituting the adhesive resin layer, such as the binder resin, the reactive compound, and the additive, and a solvent. Since the components constituting the adhesive resin layer are as described above, descriptions thereof will be omitted.

Examples of the solvent (organic solvent) include ester compounds (for example, ethyl acetate, n-butyl acetate, and isobutyl acetate) and ether compounds (for example, ethylene glycol dimethyl ether, diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, and diethylene glycol mono ethyl ether), ketone compounds (for example, methyl ethyl ketone, cyclohexanone, cyclopentanone, 2-heptanone, and 3-heptanone), hydrocarbon compounds (hexane, cyclohexane, and methylcyclohexane), as well as aromatic hydrocarbon compounds (for example, toluene and xylene).

The solvents may be used alone or in two or more kinds thereof.

A content of the solvent is preferably 0.0005% to 0.02% by mass, and more preferably 0.001% to 0.01% by mass with respect to the total mass of the composition for forming an adhesive resin layer.

A solid content of the composition for forming an adhesive resin layer is preferably 99.98% to 99.9995% by mass, and more preferably 99.99% to 99.999% by mass with respect to the total mass of the composition for forming an adhesive resin layer.

In the present specification, the “solid content” of a composition means components excluding a solvent and water. That is, the solid content of the composition for forming an adhesive resin layer is intended to be components constituting the adhesive resin layer, such as the binder resin, the reactive compound, and the additive.

A method for adhering the composition for forming an adhesive resin layer on the polymer film is not particularly limited, and examples thereof include a bar coating method, a spray coating method, a squeegee coating method, a flow coating method, a spin coating method, a dip coating method, a die coating method, an ink jet method, and a curtain coating method.

In a case where the composition for forming an adhesive resin layer adhered on the polymer film is dried, the drying conditions are not particularly limited, but the drying temperature is preferably 25° C. to 200° C. and the drying time is preferably 1 second to 120 minutes.

Step 2

In the step 2, the resin film manufactured in the step 1 and a metal foil consisting of a metal constituting the metal layer are bonded together, and the resin film and the metal foil are compressed under high temperature conditions to bond the resin film and the metal foil, thereby manufacturing a laminate having the resin layer and the metal layer.

The methods and conditions for the thermocompression of the resin film and the metal foil in the step 2 are not particularly limited, and are appropriately selected from known methods and conditions.

The temperature condition for the thermocompression is preferably 100° C. to 300° C., the pressure condition for thermocompression is preferably 0.1 to 20 MPa, and the treatment time for the thermocompression is preferably 0.001 to 1.5 hours.

Moreover, a method for producing the laminate of the embodiment of the present invention is not limited to the method having the steps 1A, 1B, and 2.

For example, the composition for forming an adhesive resin layer used in the step 1B is applied onto at least one surface of the surface of the metal foil having an RSm of 1.2 μm or less, the coating film is dried and/or cured, as necessary, to form an adhesive resin layer, a metal foil with the adhesive resin layer and the polymer film manufactured according to the method described in the step 1A are laminated so that the adhesive resin layer is in contact with the polymer film, and then, the metal foil, the adhesive resin layer, and the polymer film are subjected to thermocompression according to the method described in the step 2, whereby a laminate having the resin layer and the metal layer can be produced.

Use of Laminate

Examples of the use of the laminate include a laminated circuit board, a flexible laminated board, and a wiring board such as a flexible printed wiring board (FPC). The laminate is particularly preferably used as a high-speed communication substrate.

### EXAMPLES

Hereinbelow, the present invention will be more specifically described with reference to Examples. The materials, the amounts of materials used, the proportions, the treatment details, and the treatment procedure shown in Examples below may be modified as appropriate as long as the modifications do not depart from the spirit of the present invention. Therefore, the present invention is not limited to the aspects shown in Examples below. Furthermore, the terms “part” and “%” are based on mass unless otherwise specified.

Raw Materials

Resin Composition for Forming Polymer Layer

Liquid Crystal Polymer

LCP1: A polymer synthesized based on Example 1 of JP2019-116586A (melting point Tm: 320° C., standard dielectric loss tangent: 0.0012).

LCP1 is composed of a repeating unit derived from 6-hydroxy-2-naphthoic acid, a repeating unit derived from 4,4′-dihydroxybiphenyl, a repeating unit derived from terephthalic acid, and a repeating unit derived from 2,6-naphthalenedicarboxylic acid.

Furthermore, the standard dielectric loss tangent of LCP1 was measured by a cavity resonator perturbation method using a cavity resonator (CP-531 manufactured by Kanto Electronics Application & Development, Inc.) according to the above-mentioned method.

Polyolefin Component

PE1: “Novatec (registered trademark) LD” (low density polyethylene) manufactured by Japan Polyethylene Corporation

Compatible Components

Compatible component 1: “Bond First (registered trademark) E” manufactured by Sumitomo Chemical Co., Ltd. (copolymer of ethylene and glycidyl methacrylate (E-GMA copolymer))

Metal Foil

In each of Examples and Comparative Examples, as a metal foil, non-roughened copper foils (copper foils 1 to 4) each having a thickness of 18 μm, and RSm's of a surface in a non-roughened surface of 0.5 μm, 1.0 μm, 1.8 μm, and 2.2 μm were used.

### Example 1

A laminate having a metal layer and a resin layer was produced by the method shown below.

Manufacture of Polymer Film (Step 1A)

Supply Step

A resin composition for forming a polymer layer consisting of only a liquid crystal polymer LCP1 was pelletized using an extruder. The pelletized resin composition was dried for 12 hours using a dehumidifying hot air dryer having a heating temperature of 80° C. and a dew point temperature of −45° C. As a result, a moisture content of the pellets of the resin composition was set to 200 ppm or less. The pellets dried in this way are also referred to as a raw material A.

Film Forming Step

The raw material A in a molten state was supplied into a cylinder from the same supply port of a biaxial extruder having a screw diameter of 50 mm, heat-kneaded, discharged from a die having a die width of 750 mm onto a rotating cast roll in a form of a film, cooled, solidified, and stretched as desired to obtain a polymer film having a thickness of 150 μm.

Furthermore, the temperature of heating and kneading, the discharge rate in a case of discharging the raw material A, the clearance of the die lip, and the circumferential speed of the cast roll were each adjusted in the following ranges.
Temperature of heating and kneading: 270° C. to 350° C.
Clearance: 0.01 to 5 mm
Discharge rate: 0.1 to 1,000 mm/sec
Circumferential speed of cast roll: 0.1 to 100 m/min

Cross-Direction Stretching Step

The polymer film manufactured in the film forming step was stretched in the TD direction using a tenter. The stretching ratio at this time was 3.2 times.

Preheating Treatment

The obtained polymer film was subjected to the following heat treatment using a hot air dryer.

Both ends of the polymer film in the width direction were gripped with a jig, and the polymer film was fixed so as not to shrink in the width direction. The polymer film fixed with the jig was placed in a hot air dryer and heated for 10 seconds under the condition of a film surface temperature of 300° C., and then the polymer film was taken out from the hot air dryer.

In the preheating treatment, a film for measuring the film surface temperature was placed in the vicinity of the polymer film to be heat-treated, and the film surface temperature of the polymer film was measured using a thermocouple attached to the surface of the film for measuring the film surface temperature with a tape made of a polyimide material.

Formation of Adhesive Resin Layer (Step 1B)

Both surfaces of the polymer film that had been preheated were subjected to a corona treatment using a corona treatment device.

Next, 17.7 g of a polyimide resin solution (“PIAD-200” manufactured by Arakawa Chemical Industries, Ltd., solid content of 30% by mass, solvents: cyclohexanone, methylcyclohexane, and ethylene glycol dimethyl ether), 0.27 g of 4-t-butylphenyl glycidyl ether (manufactured by Tokyo Kasei Kogyo Co., Ltd.), and 1.97 g of cyclohexanone were mixed and stirred to prepare a composition for forming an adhesive resin layer (coating liquid 1) having a concentration of solid contents of 28% by mass.

The obtained coating liquid 1 was applied onto one surface of the surface-treated polymer film using a bar coater to form a coating film. The coating film was dried at 85° C. for 1 hour to provide an adhesive resin layer having a thickness of 1 μm. Furthermore, a coating film was similarly formed on the surface opposite to the side on which the adhesive resin layer was provided, using the coating liquid 1, and the coating film was dried to provide an adhesive resin layer, whereby a polymer film (resin film 1) having an adhesive resin layer on both sides was manufactured.

Manufacture of Laminate (Step 2)

The resin film 1 manufactured in the step and the two copper foils 1 were laminated so that the adhesive resin layer of the resin film 1 and the non-roughened surface of the copper foil 1 were in contact with each other. Next, a laminate 1 in which the metal layer, the adhesive resin layer, the polymer layer, the adhesive resin layer, and the metal layer were laminated in this order was formed by performing compression at 200° C. and 0.4 MPa for 1 hour, using a hot press machine (manufactured by Toyo Seiki Seisaku-sho, Ltd.).

The RSm at an interface between the metal layer and the adhesive resin layer in the manufactured laminate 1 was measured by the method, and found to be 0.5 μm in each case.

### Example 2

A laminate 2 of Example 2 was manufactured according to the same method as the method described in Example 1, except that a resin composition for forming a polymer layer, in which a polyolefin component (12% by mass) and a compatible component 1 (3% by mass) had been mixed, in addition to the liquid crystal polymer LCP1, was used in the supply step.

### Example 3

A laminate 3 of Example 3 was manufactured according to the same method as the method described in Example 1, except that a resin composition for forming a polymer layer, in which a polyolefin component (8% by mass) and a compatible component 1 (2% by mass) had been mixed, in addition to the liquid crystal polymer LCP1, was used in the supply step.

### Example 4

A laminate 4 of Example 4 was manufactured according to the same method as the method described in Example 1, except that a resin composition for forming a polymer layer, in which a polyolefin component (16% by mass) and a compatible component 1 (4% by mass) had been mixed, in addition to the liquid crystal polymer LCP1, was used in the supply step.

### Example 5

A laminate 5 of Example 5 was manufactured according to the same method as the method described in Example 2, except that the drying time of the coating film was increased in the step 1B.

### Example 6

A laminate 6 of Example 6 was manufactured according to the same method as the method described in Example 2, except that the drying time of the coating film was decreased in the step 1B.

### Example 7

A laminate 7 of Example 7 was manufactured according to the same method as the method described in Example 2, except that the drying time of the coating film was even shorter than that in Example 6 in the step 1B.

### Example 8

A laminate 8 of Example 8 was manufactured according to the same method as the method described in Example 2, except that a copper foil 2 having an RSm of a non-roughened surface of 1.0 μm was used instead of the copper foil 1 in the step 2.

The RSm at an interface between the metal layer and the polymer layer in the manufactured laminate 8 was measured by the above-mentioned method, and it was 1.0 μm in each case.

### Comparative Example 1

A laminate C1 of Comparative Example 1 was manufactured according to the same method as the method described in Example 2, except that a copper foil 3 having an RSm of a non-roughened surface of 1.8 μm was used instead of the copper foil 1 in the step 2.

The RSm at an interface between the metal layer and the polymer layer in the manufactured laminate C1 was measured by the method, and found to be 1.8 pin in each case.

### Comparative Example 2

A laminate C2 of Comparative Example 2 was manufactured according to the same method as the method described in Example 1, except that a resin composition for forming a polymer layer, in which a polyolefin component (37.5% by mass) and a compatible component 1 (12.5% by mass) had been mixed, in addition to the liquid crystal polymer LCP1, was used in the supply step.

### Comparative Example 3

A laminate C3 of Comparative Example 3 was manufactured according to the same method as the method described in Example 1, except that a commercially available polymer film (“CT-Q” manufactured by Kuraray Co., Ltd., thickness of 50 μm) was used instead of the polymer film manufactured in the step 1A.

### Comparative Example 4

A commercially available polymer film (“CT-Q” manufactured by Kuraray Co., Ltd., thickness of 50 μm) and two copper foils 4 having an RSm of a non-roughened surface of 2.2 jam were laminated so that the polymer film and the non-roughened surface of the copper foils 4 were in contact with each other. Next, a laminate C4 of Comparative Example 4 in which the metal layer, the polymer layer, and the metal layer were laminated in this order was formed by performing compression at 200° C. and 0.4 MPa for 1 hour, using a hot press machine (manufactured by Toyo Seiki Seisaku-sho, Ltd.).

The RSm at an interface between the metal layer and the polymer layer in the manufactured laminate C4 was measured by the method, and found to be 2.2 μm in each case.

Measurement of Resin Layer

The following measurements were performed on the resin film (corresponding to the resin layer in the laminate) manufactured by the production method of each of the examples.

Content of Solvent of Adhesive Resin Layer

A content of the solvent remaining in the adhesive resin layer formed on a surface of the resin film was determined by quantifying an outgas volatilized from the adhesive resin layer, using a gas chromatograph mass spectrometer [manufactured by Shimadzu Corporation, model: QP2010Ultra] connected with a heating desorber [manufactured by Nippon Analytical Industry Co., Ltd., model: JTD5053].

Contents of the solvent (unit: ppm by mass) with respect to the total mass of the adhesive resin layer are shown in Table 1 which will be described later.

Elastic Modulus of Adhesive Resin Layer

A fluororesin sheet was laminated on a surface of the resin film manufactured in each example, and then heated by a hot press machine (manufactured by Toyo Seiki Seisaku-sho, Ltd.) at 200° C. and 4 MPa for 1 hour to form a cured film (resin layer). After peeling the fluororesin sheet, the indentation elastic modulus of the cured film was measured by a nanoindentation method.

The measurement was performed using a Berkovich indenter, and an indentation depth at the maximum load was set to 1/10 of the thickness of the cured film. Film hardness meter: Using a Fisher Scope HM500 (manufactured by Fisher Instruments Co., Ltd.), 10 points were measured for each under the conditions of a loading time: 10 seconds and an unloading time: 10 seconds, and an arithmetic average value of the 10 points was taken as an elastic modulus after curing.

As the elastic modulus of the adhesive resin layer is higher, the distortion of a wiring board that occurs in a case where the wiring board is manufactured using the laminate is further suppressed.

Furthermore, with respect to a sample A consisting of only a resin layer manufactured from each laminate according to the method described in the evaluation of cracking properties which will be described later, the elastic modulus was measured according to the method, and in each example, the measured value of the indentation elastic modulus of the sample A was the same as the measured value of the indentation elastic modulus of the cured film.

Dielectric Loss Tangent of Resin Layer

A center part of the resin film manufactured in each example was sampled, and the dielectric loss tangent in a frequency band of 28 GHz was measured in an environment at a temperature of 23° C. and a humidity of 50% RH, using a split cylinder type resonator (“CR-728” manufactured by Kanto Electronics Application & Development, Inc.) and a network analyzer (Keysight N5230A).

Polyolefin Dispersed Phase

A cross-section of the resin film in the thickness direction was observed by the following method, using a scanning electron microscope (SEM), the presence or absence of the formation of a polyolefin dispersed phase in the polymer layer was confirmed from the obtained observation image, and in a case where the dispersed phase was formed, an average dispersion diameter of the dispersed phase was determined.

At 10 different sites on the sample, a fractured surface parallel to a width direction of the resin film and perpendicular to a film surface and a fractured surface perpendicular to the width direction and perpendicular to the film surface were observed to obtain a total of 20 observation images. The observation was carried out at an appropriate magnification of 100 to 100,000 times, and images were taken so that the dispersed state of the particles (dispersed phase formed by the polyolefin) in the width of the entire thickness of the film could be confirmed.

For 200 particles randomly selected from each of the 20 images, the outer circumference of each particle was traced, and the equivalent circle diameter of the particles was measured from these trace images with an image analyzer to determine the particle diameter. An average value of the particle diameter measured from each image taken was defined as the average dispersion diameter of the dispersed phase.

Evaluation of Laminate

The following evaluation tests were performed on the laminates manufactured by the production method of each of the examples.

Transmission Characteristics

By the method shown below, a sample for evaluation of transmission characteristics having a transmission path of a microstrip line structure was manufactured from each laminate.

Each laminate was cut into a size of 15 cm×15 cm to manufacture a substrate for a sample for evaluation of transmission characteristics, and a microstrip line transmission path was formed on the manufactured substrate. The microstrip line transmission path was formed by laminating a mask layer on one metal layer of each laminate, exposing the mask layer so that a pattern of the microstrip line transmission path could be formed, then removing unnecessary sites of the mask to form mask patterns, immersing a surface of the metal layer on which the mask pattern had been laminated in a 40% aqueous iron (III) chloride solution (manufactured by FUJIFILM Wako Pure Chemical Corporation, first grade), and dissolving the metal layer by an etching treatment. A size of the microstrip line transmission path was 10 cm in length and 105 μm in width.

In this manner, a microstrip line transmission path in which the signal line of a metal layer was formed on one surface and the surface of the other metal layer was ground was obtained.

For a sample manufactured by the method, a transmission loss (S21 parameter, unit: dB/cm) in a frequency band of 28 GHz was measured in an environment of a temperature of 23° C. and a humidity of 50% RH, using a split cylinder type resonator (“CR-728” manufactured by Kanto Electronics Application & Development, Inc.) and a network analyzer (Keysight N5230A).

Adhesiveness

Each laminate was cut into strips of 1 cm×5 cm to manufacture a sample for evaluation of adhesiveness. A peel strength (unit: kN/m) of the obtained sample was measured according to the method for measuring a peel strength of the flexible printed wiring board described in JIS C 5016-1994. An adhesiveness measurement test was carried out by peeling off the copper foil at a peeling speed of 50 mm/min in a direction at an angle of 90° with respect to a copper foil removal surface, using a tensile tester (manufactured by IMADA Co., Ltd., Digital Force Gauge ZP-200N). The adhesiveness between the metal layer and the resin layer was evaluated based on the values measured by a tensile tester.

Cracking Properties

A sample A (size of 100 mm×100 mm) consisting of only a resin layer was manufactured by immersing the laminate in a 40% aqueous iron (III) chloride solution (manufactured by FUJIFILM Wako Pure Chemical Corporation, first grade) and dissolving the metal layer by an etching treatment. Next, a stress in a case where the both ends of the obtained sample A were stretched along the longitudinal direction were measured in an environment of 23° C., using a Tensilon tester [Strograph VE50, manufactured by Toyo Seiki Seisakusho Co., Ltd.] according to the method described in JIS K 7161-1: 2014, and the tensile elastic modulus (unit: GPa) was measured.

The cracking properties (easiness of cracking) of the resin layer were evaluated from the obtained tensile elastic modulus. The lower the tensile elastic modulus measured by the method, the more easily the resin layer is cracked, and the higher the tensile elastic modulus measured by the method, the more difficult the resin layer is cracked.

Results

The configurations of each layer constituting the laminates produced in each Example and each Comparative Example, and the evaluation results of each laminate are shown in Table 1 below.

The “Resin composition” column in Table 1 shows the type and composition of the resin composition for forming a polymer layer used in each example.

The “Coating liquid” column in Table 1 shows the type and composition of the resin composition for forming an adhesive resin layer used in each example.

“-” in the “Thickness” column and the “Solvent content” column of the “Adhesive resin layer” in Table 1 means that there is no adhesive resin layer.

The “Dispersed phase average dispersion diameter” column of Table 1 shows the average dispersion diameter (unit: μm) of the polyolefin dispersed phase in each resin film measured by the method.

TABLE 1

| | | | Resin layer | | | | | | | |
|---|---|---|---|---|---|---|---|---|---|---|
| | | | Polymer layer | | | | | | | |
| | | | Resin composition | | | | | | | |
| | | | | Content of | | | | Adhesive resin layer | | |
| | Thickness | | | liquid | | Content of | | Coating liquid | | |
| | of metal | RSm at | | crystal | Content of | compatible | | | Binder | Reactive |
| | layer | interface | | polymer | polyolefin | component | Thickness | | resin | compound |
| | [μm] | [μm] | Type | [%] | [%] | [%] | [μm] | Type | [parts] | [parts] |
| Example 1 | 18 | 0.5 | Compo- | 100 | 0 | 0 | 50 | Coating | 95 | 5 |
| | | | sition 1 | | | | | liquid 1 | | |
| Example 2 | 18 | 0.5 | Compo- | 85 | 12 | 3 | 50 | Coating | 95 | 5 |
| | | | sition 2 | | | | | liquid 1 | | |
| Example 3 | 18 | 0.5 | Compo- | 90 | 8 | 2 | 50 | Coating | 95 | 5 |
| | | | sition 3 | | | | | liquid 1 | | |
| Example 4 | 18 | 0.5 | Compo- | 80 | 16 | 4 | 50 | Coating | 95 | 5 |
| | | | sition 4 | | | | | liquid 1 | | |
| Example 5 | 18 | 0.5 | Compo- | 85 | 12 | 3 | 50 | Coating | 95 | 5 |
| | | | sition 2 | | | | | liquid 2 | | |
| Example 6 | 18 | 0.5 | Compo- | 85 | 12 | 3 | 50 | Coating | 95 | 5 |
| | | | sition 2 | | | | | liquid 3 | | |
| Example 7 | 18 | 0.5 | Compo- | 85 | 12 | 3 | 50 | Coating | 95 | 5 |
| | | | sition 2 | | | | | liquid 4 | | |
| Example 8 | 18 | 1.0 | Compo- | 85 | 12 | 3 | 50 | Coating | 95 | 5 |
| | | | sition 2 | | | | | liquid 1 | | |
| Comparative | 18 | 1.8 | Compo- | 85 | 12 | 3 | 50 | Coating | 95 | 5 |
| Example 1 | | | sition 2 | | | | | liquid 1 | | |
| Comparative | 18 | 0.5 | Compo- | 50 | 37.5 | 12.5 | 50 | Coating | 95 | 5 |
| Example 2 | | | sition 5 | | | | | liquid 1 | | |

| | | | | | | | |
|---|---|---|---|---|---|---|---|
| Comparative | 18 | 0.5 | (CT-Q manufactured by | 50 | 1 | 95 | 5 |
| Example 3 | | | Kuraray Co., Ltd.) | | | | |
| Comparative | 18 | 2.2 | (CT-Q manufactured by | 50 | None | — | — |
| Example 4 | | | Kuraray Co., Ltd.) | | | | |

| | Resin layer | | | | | | | |
|---|---|---|---|---|---|---|---|---|
| | | | | | Average | | | |
| | | | | | dispersion | | | |
| | Adhesive resin layer | | | | diameter of | Evaluation | | |
| | | Content of | Elastic | Dielectric | dispersed | Transmission | | Cracking |
| | Thickness | solvent | modulus | loss | phase | loss | Adhesiveness | properties |
| | [μm] | [ppm] | [GPa] | tangent | [μm] | [dB/cm] | [kN/m] | [GPa] |
| Example 1 | 1 | 30 | 1.3 | 0.0010 | — | −0.31 | 0.71 | 1.1 |
| Example 2 | 1 | 30 | 1.3 | 0.0012 | 2.1 | −0.32 | 0.72 | 3.2 |
| Example 3 | 1 | 30 | 1.3 | 0.0011 | 2.0 | −0.31 | 0.70 | 2.4 |
| Example 4 | 1 | 30 | 1.3 | 0.0013 | 2.3 | −0.35 | 0.72 | 3.5 |
| Example 5 | 1 | 5 | 1.3 | 0.0012 | 2.1 | −0.32 | 0.70 | 3.2 |
| Example 6 | 1 | 185 | 1.3 | 0.0012 | 2.1 | −0.33 | 0.71 | 3.2 |
| Example 7 | 1 | 950 | 1.3 | 0.0012 | 2.1 | −0.35 | 0.65 | 3.2 |
| Example 8 | 1 | 30 | 1.3 | 0.0012 | 2.1 | −0.33 | 0.72 | 3.2 |
| Comparative | 1 | 30 | 1.3 | 0.0012 | 2.1 | −0.36 | 0.74 | 3.2 |
| Example 1 | | | | | | | | |
| Comparative | 1 | 30 | 1.3 | 0.0022 | 3.9 | −0.40 | 0.68 | 4.3 |
| Example 2 | | | | | | | | |
| Comparative | 1 | 30 | 1.3 | 0.0022 | — | −0.40 | 0.60 | 3.6 |
| Example 3 | | | | | | | | |
| Comparative | — | — | — | 0.0022 | — | −0.46 | 0.82 | 3.6 |
| Example 4 | | | | | | | | |

From the results shown in the tables, it was confirmed that the object of the present invention can be accomplished with the laminate of the embodiment of the present invention.

What is claimed is:

1. A laminate comprising:
a metal layer; and
a resin layer in contact with at least one surface of the metal layer,
wherein a dielectric loss tangent of the resin layer at a temperature of 23° C. and a frequency of 28 GHz is less than 0.002, and
an average length RSm of a roughness curve element at an interface between the metal layer and the resin layer in a cross-section along a thickness direction is 1.2 μm or less.

2. The laminate according to claim 1,
wherein the resin layer includes a liquid crystal polymer.

3. The laminate according to claim 2,
wherein the liquid crystal polymer includes two or more kinds of repeating units derived from a dicarboxylic acid.

4. The laminate according to claim 2,
wherein the liquid crystal polymer has at least one selected from the group consisting of a repeating unit derived from 6-hydroxy-2-naphthoic acid, a repeating unit derived from an aromatic diol, a repeating unit derived from terephthalic acid, and a repeating unit derived from 2,6-naphthalenedicarboxylic acid.

5. The laminate according to claim 1,
wherein the resin layer includes a polyolefin.

6. The laminate according to claim 5,
wherein a content of the polyolefin is 0.1% to 40% by mass with respect to a total mass of the resin layer.

7. The laminate as according to claim 5,
wherein a dispersed phase including the polyolefin is formed in the resin layer, and
an average dispersion diameter of the dispersed phase in an observation image obtained by observing a cross-section of the resin layer is 0.01 to 10 μm.

8. The laminate according to claim 1,
wherein the resin layer has an adhesive resin layer and a layer including a liquid crystal polymer in this order from a metal layer side.

9. The laminate according to claim 8,
wherein a thickness of the adhesive resin layer is 1 μm or less.

10. The laminate according to claim 8,
wherein an elastic modulus of the adhesive resin layer is 0.8 GPa or more.

11. The laminate according to claim 8,
wherein a content of a solvent included in the adhesive resin layer is 0 to 200 ppm by mass with respect to a total mass of the adhesive resin layer.

12. The laminate according to claim 5,
wherein the resin layer has an adhesive resin layer and a layer including a liquid crystal polymer in this order from a metal layer side.

13. The laminate according to claim 12,
wherein a content of a solvent included in the adhesive resin layer is 0 to 200 ppm by mass with respect to a total mass of the adhesive resin layer.

14. The laminate according to claim 6,
wherein the resin layer has an adhesive resin layer and a layer including a liquid crystal polymer in this order from a metal layer side.

15. The laminate according to claim 14,
wherein a content of a solvent included in the adhesive resin layer is 0 to 200 ppm by mass with respect to a total mass of the adhesive resin layer.

16. The laminate according to claim 1,
wherein the metal layer is a copper layer.
